(19) United States
(12) Patent Application Publication
(10) Pub. No.: US 2023/0027486 A1
(43) Pub. Date: Jan. 26, 2023

(54) RAMAN SPECTROMETER

(71) Applicant: PERKINELMER SINGAPORE PTE. LTD., Singapore (SG)

(72) Inventors: Ben PERSTON, Beaconsfield, Bucks (GB); Paul STYLES, Beaconsfield, Bucks (GB); Ralph Lance CARTER, Beaconsfield, Bucks (GB)

(21) Appl. No.: 17/780,286

(22) PCT Filed: Nov. 26, 2020
(86) PCT No.: PCT/GB2020/053021

§ 371 Date: May 26, 2022

(30) Foreign Application Priority Data
Nov. 27, 2019 (GB) 1917276.6

(51) Int. Cl. G01J 3/44; G01J 3/02

(52) U.S. Cl. CPC G01J 3/44; G01J 3/0202; G01J 3/0264; G01J 2003/423

(57) ABSTRACT

A Raman spectrometer arrangement comprising a Raman spectrometer 1 having a laser 1001 for illuminating a sample S and a spectrometer accessory 4 configured to be mounted on the spectrometer, wherein the spectrometer accessory comprises a surface configured to receive the sample S. The Raman spectrometer arrangement is configured to operate in at least a first configuration and a second configuration, wherein the first configuration is such that the laser 1001 illuminates the sample S before reaching a level of the surface and the second configuration is such that the laser 1001 reaches the level of the surface before illuminating the sample S.

### TECHNICAL FIELD

Aspects of the present application relate to Raman spectrometers. Some aspects relate to Raman spectrometer arrangements comprising a Raman spectrometer and an accessory which is mountable on the spectrometer. Some aspects further relate to Raman spectrometers themselves and accessories for Raman spectrometers. Other aspects relate to Raman spectrometers including an auto-focusing system as well as a method of auto-focusing a Raman spectrometer and a method for determining a weighting vector for use in a Raman spectrometer and/or a method of focusing a Raman spectrometer.

### BACKGROUND

Raman spectrometers are used to analyse a variety of samples by illuminating the sample with the light from a laser and analysing Raman scattered light resulting from excitation by the illumination light. A wide range of samples can be analysed by Raman spectroscopy including liquids, solids and samples contained in packaging material. In some circumstances it can be convenient to analyse a sample using Raman spectroscopy where the Raman spectra will be acquired through another piece of material, typically a piece of packaging material in which the sample is contained, or a container such as petri dish or vial holding the sample.

### SUMMARY

According to one aspect of the invention there is provided a Raman spectrometer arrangement comprising:
a Raman spectrometer having a laser for illuminating a sample; and
a spectrometer accessory configured to be mounted on the spectrometer, wherein the spectrometer accessory comprises a surface configured to receive the sample,
wherein the Raman spectrometer arrangement is configured to operate in at least a first configuration and a second configuration, wherein:
the first configuration is such that the laser illuminates the sample before reaching a level of the surface; and

the second configuration is such that the laser reaches the level of the surface before illuminating the sample.

This can provide enhanced usability of the system allowing a configuration to be selected by a user in dependence on the nature of the sample to be analysed.

In some embodiments the Raman spectrometer arrangement is configured to be usable in two orientations, a first orientation where the accessory acts as a base on which the Raman spectrometer arrangement is supportable in use and a second orientation where the spectrometer acts as a base on which the Raman spectrometer arrangement is supportable in use.

In some embodiments the first configuration is such that the spectrometer accessory is in contact with a surface of a table and the Raman spectrometer not in contact with the table; and the second configuration is such that the Raman spectrometer is in contact with the surface of the table and the spectrometer accessory is not in contact with the table.

The spectrometer accessory may comprise a main body comprising an opening through which a sample is introducible into the accessory for illumination when on the surface configured to receive the sample.

The spectrometer accessory may comprise a removable portion which comprises said surface configured to receive a sample such that a sample is depositable on the removable portion outside of the accessory before the removable portion is introduced through the opening into the main body.

In some embodiments the spectrometer arrangement comprises optical components for guiding radiation along an optical path from the laser to said surface configured for receiving the sample, the spectrometer comprises a main housing in which the laser is provided, and the spectrometer arrangement is arranged so that changing between the first configuration and the second configuration is achievable without a change in alignment of the optical path relative to the main housing.

This can allow the production of an arrangement with a simple design—minimising the number of moving parts.

In some embodiments the spectrometer accessory comprises:
a main body comprising an opening; and
a drawer comprising said surface configured to receive the sample, the drawer being configured to be inserted in the opening of the main body in a first orientation and a second orientation, wherein:

the first orientation is such that the surface is facing upward when the Raman spectrometer arrangement is in the first configuration; and

the second orientation is such that the surface is facing upward when the Raman spectrometer arrangement is in the second configuration.

The accessory may be arranged so that a sample is locatable on a side of the drawer which faces away from the spectrometer when the spectrometer arrangement is to be used in an orientation with the drawer above the spectrometer, wherein a window is provided in the drawer through which the beam of the laser and any resulting Raman emission may pass.

The accessory may be arranged so that a sample is locatable on a side of the drawer which faces towards the spectrometer when the spectrometer arrangement is to be used in an orientation with the drawer below the spectrometer.

The spectrometer may be arranged for operating in autofocus mode when the spectrometer is in one orientation and may be arranged for operating in a fixed focus mode when the spectrometer is in another orientation.

The spectrometer may be arranged for operating in autofocus mode when a first type of accessory is mounted on the spectrometer and the spectrometer is in one orientation and may be arranged for operating in a fixed focus mode when the first type of accessory is mounted on the spectrometer but the spectrometer is in another orientation.

The spectrometer may comprise a screen for displaying information to a user, the screen being mounted for movement between a first position for use when the spectrometer is in a first orientation and a second position for use when the spectrometer is used in a second orientation.

In some embodiments, in one state the screen projects from a main body of the spectrometer and helps support the spectrometer in use.

The Raman spectrometer arrangement may further comprise a fiber for coupling the laser to the sample.

The Raman spectrometer arrangement may further comprise an interlock mechanism for controlling operation of the laser wherein the interlock arrangement enables operation of the laser when the accessory is mounted on the spectrometer and disables operation of the laser when the accessory is not mounted on the spectrometer.

In some embodiments the accessory is selected from a set of accessories each of which is mountable on the spectrometer.

In some embodiments at least one of the accessories in the set is such as to lead to an overall spectrometer arrangement which can be classified as a Class I device notwithstanding the fact that the laser is a higher Class laser, whereas another of the accessories is such as to lead to an overall spectrometer arrangement which will be classified as a device which has the same Class as the Class of the laser.

The laser may be driven by a laser current and the interlock arrangement may be arranged to control operation of the laser by controlling the laser current.

In some embodiments the spectrometer arrangement comprises an electrical conduction path for carrying laser current between a power source and the laser, wherein the interlock arrangement comprises an electrical conductor portion which is provided in the accessory such that when the accessory is mounted on the spectrometer the electrical conductor portion forms part of the conduction path enabling operation of the laser and when the accessory is absent the conduction path is broken so disabling the laser.

In some embodiments the spectrometer comprises a pair of electrical contacts for connecting to the conduction path in the spectrometer and the accessory comprises a corresponding pair of electrical contacts for connecting to the electrical conductor portion in the accessory such that when the accessory is correctly installed on the spectrometer a first of the electrical contacts on the accessory mechanically and electrically contacts with a first of the electrical contacts on the spectrometer and a second of the electrical contacts on the accessory mechanically and electrically contacts with a second of the electrical contacts on the spectrometer so connecting the electrical conduction portion into the electrical conduction path.

The spectrometer may comprise a focus system for focusing the beam of the laser on a sample. The focus system may have an autofocus mode and a fixed focus mode.

The accessory may be arranged so that when the accessory is installed on the spectrometer the laser beam path is obscured from view.

The accessory may have an operative configuration in which a carried sample is to be illuminated by the laser and loading configuration for allowing loading of a sample into the accessory.

The accessory may be arranged so that, when the accessory is installed on the spectrometer and in the operative configuration, the laser beam path is obscured from view.

In some embodiments the accessory comprises an electrical conductor portion which is provided in the accessory such that when the accessory is mounted on the spectrometer the electrical conductor portion forms part of the conduction path enabling operation of the laser and further comprises an accessory switch which when in an open state interrupts the conduction path via the electrical conductor portion so as to disable operation of the laser.

The accessory may be arranged so that said accessory switch adopts the open state when the accessory is in the loading configuration.

In some embodiments the drawer is movable between an open configuration in which the drawer is at least partly withdrawn from the main body of the accessory so allowing loading of a sample onto the drawer and a closed configuration where the surface configured to receive the sample is located within the main body of the accessory to allow illumination by the laser of a carried sample and wherein said accessory switch adopts the open state when the drawer is in the open configuration. According to another aspect of the invention there is provided a Raman spectrometer arrangement kit comprising:
a Raman spectrometer having a laser for illuminating a sample; and
at least two spectrometer accessories each of which is selectably mountable on the spectrometer,
wherein at least one of the accessories comprises a surface configured to receive the sample and with said at least one of the accessories mounted on the spectrometer the Raman spectrometer arrangement is configured to operate in at least a first configuration and a second configuration, wherein: the first configuration is such that the laser illuminates the sample before reaching a level of the surface; and
   the second configuration is such that the laser reaches the level of the surface before illuminating the sample.

In some embodiments the first configuration is such that said at least one spectrometer accessory is in contact with a surface of a table and the Raman spectrometer not in contact with the table; and

the second configuration is such that the Raman spectrometer is in contact with the surface of the table and said at least one spectrometer accessory is not in contact with the table.

In some embodiments said at least one of the spectrometer accessories comprises:
a main body comprising an opening; and
a drawer comprising said surface configured to receive the sample, the drawer being configured to be inserted in the opening of the main body in a first orientation and a second orientation, wherein: the first orientation is such that said surface is facing upward when the Raman spectrometer arrangement is in the first configuration; and
   the second orientation is such that said surface is facing upward
when the Raman spectrometer arrangement is in the second configuration.

The Raman spectrometer arrangement kit may further comprise an interlock arrangement for controlling operation of the laser wherein the interlock arrangement enables operation of the laser when either one of the accessories is mounted on the spectrometer and disables operation of the laser when neither accessory is mounted on the spectrometer.

In some embodiments at least one of the at least two spectrometer accessories is such as to lead to an overall spectrometer arrangement which will be classified as a Class I device notwithstanding the fact that the laser is a higher Class laser, whereas another of the at least two spectrometer accessories is such as to lead to an overall spectrometer arrangement which will be classified as a device which has the same Class as the Class of the laser.

At least one of the accessories may comprise an interlock collar for mounting on the spectrometer for handheld use.

According to another aspect of the invention there is provided a Raman spectrometer accessory for mounting on a Raman spectrometer to form a Raman spectrometer arrangement configured to operate in at least a first configuration such that the spectrometer accessory is in contact with a surface of a table and the Raman spectrometer not in contact with the table and a second configuration is such that the Raman spectrometer is in contact with the surface of the table and the spectrometer accessory is not in contact with the table, the portable Raman spectrometer accessory comprising:
a main body comprising an opening; and
a drawer comprising a surface configured to receive the sample, the drawer being configured to be inserted in the opening of the main body in a first orientation and a second orientation, wherein:
   the first orientation is such that the surface is facing upward when the Raman spectrometer arrangement is in the first configuration; and
   the second orientation is such that the surface is facing upward when the Raman spectrometer arrangement is in the second configuration.

According to another aspect of the present invention there is provided a Raman spectrometer arrangement comprising:

a Raman spectrometer having a laser for illuminating a sample,

a spectrometer accessory which is mountable on the spectrometer, and an interlock arrangement for controlling operation of the laser wherein the interlock arrangement enables operation of the laser when the accessory is mounted on the spectrometer and disables operation of the laser when the accessory is not mounted on the spectrometer.

In some cases, this may result in a safer instrument where operation of the laser is disabled in the absence of the accessory. This, for example, can lead to an overall spectrometer arrangement which can be classified as a Class I device notwithstanding the fact that it includes say a Class IIIB laser.

Further the provision of an accessory which is mountable to the spectrometer may lead to the possibility of providing different accessories for different purposes.

In one set of embodiments the accessory is selected from a set of accessories each of which is mountable on the spectrometer.

In one set of embodiments of the invention at least one of the accessories in the set may be such as to lead to an overall spectrometer arrangement which can be classified as a Class I device notwithstanding the fact that the laser is a higher Class laser, say a Class IIIB laser, whereas another of the accessories may be such as to lead to an overall spectrometer arrangement which will be classified as a device which has the same Class as the Class of the laser, say a Class IIIB device.

The laser may be driven by electrical current known as a laser current, for example the laser may be a diode laser driven by a laser current.

The interlock arrangement may be arranged to control operation of the laser by controlling the laser current.

In some embodiments the interlock arrangement may comprise a switch for allowing the laser current to flow when the accessory is mounted on the spectrometer and interrupting the laser current when the accessory is not mounted on the spectrometer. The switch may comprise a microswitch or a reed switch which is switched to an “on” state when the accessory is mounted on the spectrometer.

Preferably the spectrometer arrangement comprises an electrical conduction path for carrying the laser current between a power source and the laser, wherein the interlock arrangement comprises an electrical conductor portion which is provided in the accessory such that when the accessory is mounted on the spectrometer the electrical conductor portion forms part of the conduction path enabling operation of the laser and when the accessory is absent the conduction path is broken so disabling the laser.

This provides a particularly simple, effective and failsafe interlock arrangement. The laser simply cannot operate without a suitable accessory in place and there is no mechanical or electronic switch or similar that needs to be installed or maintained or might fail.

The spectrometer may comprise a pair of electrical contacts and the accessory may comprise a corresponding pair of electrical contacts such that when the accessory is correctly installed on the spectrometer a first of the electrical contacts on the accessory mechanically and electrically contacts with a first of the electrical contacts on the spectrometer and a second of the electrical contacts on the accessory mechanically and electrically contacts with a second of the electrical contacts on the spectrometer.

In one set of embodiments the spectrometer comprises a pair of electrical contacts for connecting to the conduction path in the spectrometer and the accessory comprises a corresponding pair of electrical contacts for connecting to the electrical conductor portion in the accessory such that when the accessory is correctly installed on the spectrometer a first of the electrical contacts on the accessory mechanically and electrically contacts with a first of the electrical contacts on the spectrometer and a second of the electrical contacts on the accessory mechanically and electrically contacts with a second of the electrical contacts on the spectrometer so connecting the electrical conduction portion into the electrical conduction path.

This can help ensure that the user correctly installs the accessory on the spectrometer, in terms of relative orientation say, since the device will not operate until this is achieved.

The spectrometer may comprise a detector for detecting a Raman signal, illumination optics for directing the beam of the laser to the sample, and collection optics for collecting a Raman emission from the sample and directing this towards the detector.

The spectrometer may comprise a focus system for focusing the beam of the laser on a sample. The focus system may comprise an autofocus system.

The focus system may have an autofocus mode and a fixed focus mode. The focus in the fixed focus mode may be determined by a user or based on determinations made by the spectrometer arrangement.

Optical components may form part of the illumination optics and form part of the collection optics. Optical components used in this way may be termed “common optical components”.

The spectrometer may comprise an objective lens. The objective lens may form part of the illumination optics and may form part of the collection optics.

The autofocus system may comprise a drive system for moving the objective lens along the optical axis of the lens relative to the remainder of the spectrometer. This can facilitate movement of the lens relative to a sample.

Below various optional features of the accessory are defined. It will be noted that where there are accessories of different types some of these features may be present in some types of accessory but not present in other types of accessory.

The accessory may be arranged so that when the accessory is installed on the spectrometer the laser beam path is obscured from view.

The accessory may have an operative configuration in which a carried sample is to be illuminated by the laser and loading configuration for allowing loading of a sample into the accessory. The accessory may be arranged so that, when the accessory is installed on the spectrometer and in the operative configuration, the laser beam path is obscured from view.

The accessory may be arranged so that even when the accessory is in the loading configuration user viewing of the laser beam is blocked.

The accessory may comprise the electrical conductor portion which is provided in the accessory such that when the accessory is mounted on the spectrometer the electrical conductor portion forms part of the conduction path enabling operation of the laser and further comprise an accessory switch which when in an open state interrupts the conduction path via the electrical conductor portion so as to disable operation of the laser.

The accessory may be arranged so that said accessory switch adopts the open state when the accessory is in the loading configuration. The accessory may be arranged so that said switch adopts a closed state so as to allow current flow through the switch when the accessory is in the operative configuration.

The accessory may comprise a sample holding portion. The sample holding portion may be arranged for holding a sample holding vessel—such as a vial or a petri dish. The accessory may comprise a vial holding portion. The accessory may comprise a petri dish holding portion.

The sample holding portion may be arranged for holding a sample directly.

The accessory may comprise a lid or door portion which is movable between an open configuration in which a sample may be loaded onto the sample holding portion and a closed configuration where the lid or door obscures access to the sample holding portion. The open configuration can be considered a loading configuration. The closed configuration can be considered an operative configuration.

The accessory may be arranged so that said accessory switch adopts the open state when the lid or door portion is in said open configuration. The accessory may be arranged so that said switch adopts a closed state so as to allow current flow through the switch when the lid or door portion is in said closed configuration.

The accessory may comprise a vial holder as the sample holding portion and comprise a lid or door portion which is movable between an open configuration in which a vial may be loaded into the vial holder and a closed configuration where the lid or door obscures access to the vial holder.

The sample holding portion may comprise a drawer which is movable between an open configuration in which the drawer is at least partly withdrawn from a main body of the accessory so allowing loading of a sample onto the sample holding portion and a closed configuration where the sample holding portion is located within a main body of the accessory to allow illumination by the laser of a carried sample.

The accessory may be arranged so that when the drawer is in the closed configuration the laser beam path is obscured from view.

The accessory may be arranged so that even when the drawer is in the open configuration user viewing of the laser beam is blocked.

The accessory may be arranged so that said accessory switch adopts the open state when the drawer is in the open configuration. The accessory may be arranged so that said switch adopts a closed state so as to allow current flow through the switch when the drawer is in said closed configuration.

The accessory may be arranged so that a sample holding vessel may be located on a side of the sample holding portion, say the drawer, which faces away from the spectrometer when the spectrometer arrangement is to be used in an orientation with the sample holding portion above the spectrometer, wherein a window is provided in the sample holding portion, say the drawer, through which the beam of the laser and any resulting Raman emission may pass.

The window may, say, comprise an opening or comprise a material which is at least partly transparent to electromagnetic radiation in the frequencies of interest.

With this orientation the location of the sample can be well known—ie at the level of a base of the sample holder or at the bottom of a sample holding vessel disposed on the sample holder. This can avoid the need for use of adjustable or auto focusing of the illumination and collection system in the spectrometer. However the material of the holder vessel and/or drawer may interfere with results.

The accessory may be arranged so that a sample holding vessel may be located on a side of the sample holding portion, say the drawer, which faces towards the spectrometer when the spectrometer arrangement is to be used in an orientation with the sample holding portion below the spectrometer.

With this orientation the presence of any material between the sample and the illumination and collection system in the spectrometer can be avoided, but the precise location of the sample may vary (in height above the holder vessel and/or drawer). This then can call for adjustable or auto focusing to yield good results.

The accessory may comprise an interlock collar for mounting on the spectrometer for handheld use. The primary function of the interlock collar may be to cause the interlock arrangement to enter a state where operation of the laser is enabled.

For example, the interlock collar may comprise the electrical conductor portion such that when the interlock collar is mounted on the spectrometer the electrical conductor portion forms part of the conduction path enabling operation of the laser.

The interlock collar may comprise a shroud portion for surrounding components of the illumination optics and/or the collection optics.

The spectrometer may be arranged for operating in autofocus mode when a first type of accessory is mounted on the spectrometer and may be arranged for operating in a fixed focus mode when a second type of accessory is mounted on the spectrometer.

The spectrometer may be arranged for operating in autofocus mode when the spectrometer is in one orientation and may be arranged for operating in a fixed focus mode when the spectrometer is in another orientation.

The spectrometer may be arranged for operating in autofocus mode when a first type of accessory is mounted on the spectrometer and the spectrometer is in one orientation and may be arranged for operating in a fixed focus mode when the first type of accessory is mounted on the spectrometer but the spectrometer is in another orientation.

The spectrometer arrangement may comprise determination means for determining which type of accessory is mounted on the spectrometer. The spectrometer arrangement may comprise determination means for determining the orientation of the spectrometer.

The spectrometer arrangement may comprise control means for controlling operation of the focus system in dependence on determinations made by the determination means.

The location for the focus in fixed focus mode may be determined by the determination means in dependence on the type of accessory mounted on the spectrometer. The location for the focus in fixed focus mode may be determined in dependence on, or set by, input from the user.

The type of accessory mounted on the spectrometer may be determined based on an indication given by the user or by the system detecting the type of accessory mounted on the spectrometer.

The orientation of the spectrometer may be determined based on an indication given by the user or by the system detecting the orientation of the spectrometer.

The spectrometer may comprise a screen for displaying information to a user. For example this screen may be an LCD screen and may for example display menu options for use in controlling the spectrometer and/or may display data concerning investigations made using the spectrometer.

The screen may be mounted for movement between a first position for use when the spectrometer is used in a first orientation and a second position for use when the spectrometer is used in a second orientation.

The first orientation may be an orientation where the sample is to be located below the spectrometer. The second orientation may be an orientation where the sample is to be located above the spectrometer.

The screen may be movable between a state where it faces towards the same direction as the laser beam leaves the spectrometer in use and a state where it faces towards an opposite direction.

The screen may be hingedly mounted to a main body of the spectrometer.

The screen may be flush with the main body in one state and project from the main body in another state. Where the screen projects from the main body, the screen may help support the spectrometer in use.

The spectrometer may comprise a computer for controlling overall operation of the spectrometer. The determination means may comprise the computer operating under control of software. The control means may comprise the computer operating under control of software.

According to another aspect of the present invention there is provided a Raman spectrometer arrangement kit comprising:

a Raman spectrometer having a laser for illuminating a sample,

at least two spectrometer accessories each of which is selectably mountable on the spectrometer, and

an interlock arrangement for controlling operation of the laser wherein the interlock arrangement enables operation of the laser when either one of the accessories is mounted on the spectrometer and disables operation of the laser when neither accessory is mounted on the spectrometer.

In one set of embodiments of the invention at least one of the at least two spectrometer accessories may be such as to lead to an overall spectrometer arrangement which can be classified as a Class I device notwithstanding the fact that the laser is a higher Class laser, say a Class IIIB laser, whereas another of the at least two spectrometer accessories may be such as to lead to an overall spectrometer arrangement which will be classified as a device which has the same Class as the Class of the laser, say a Class IIIB device.

According to another aspect of the present invention there is provided a Raman spectrometer accessory for mounting on a Raman spectrometer in a spectrometer arrangement as defined above.

According to another aspect of the present invention there is provided a Raman spectrometer for receiving a spectrometer accessory in a spectrometer arrangement as defined above.

According to another aspect of the present invention there is provided a Raman spectrometer having a laser for illuminating a sample and an electrical conduction path for carrying the laser current between a power source and the laser, which conduction path comprises a pair of electrical contacts available for connection thereto by a spectrometer accessory and such that electrical connection between the electrical contacts enables completion of the electrical conduction path to enable operation of the laser.

According to another aspect of the present invention there is provided a Raman spectrometer accessory for mounting on a Raman spectrometer having a laser for illuminating a sample and an electrical conduction path for carrying the laser current between a power source and the laser, which conduction path comprises a pair of electrical contacts available for connection thereto by a spectrometer accessory and such that electrical connection between the electrical contacts enables completion of the electrical conduction path to enable operation of the laser, the accessory comprising,

a corresponding pair of electrical contacts and an electrical conductor portion therebetween such that when the accessory is correctly installed on the spectrometer a first of the electrical contacts on the accessory mechanically and electrically contacts with a first of the electrical contacts on the spectrometer and a second of the electrical contacts on the accessory mechanically and electrically contacts with a second of the electrical contacts on the spectrometer such that the electrical conductor portion forms part of the conduction path enabling operation of the laser.

The Raman spectrometer may comprise an auto-focusing system for focusing the laser on the sample under investigation, and a detector for detecting Raman spectra emitted in response to illumination by the laser,
wherein the auto-focusing system comprises at least one adjustable focusing element for adjusting the location of the focus of the laser, a determination unit for determining a selected location for the focus of the laser, and a controller for adjusting the adjustable focusing element to focus the laser at said selected location determined by the determination unit,
wherein the auto-focusing system is arranged under the control of software to enable determination of the selected location for the focus of the laser by: using the controller to adjust the adjustable focusing element to focus the laser at a plurality of trial locations,
receiving at the determination unit detected Raman spectra from the detector at each of said plurality of trial locations,
determining at the determination unit a signal strength metric from each detected spectrum which is representative of the strength of the Raman spectrum detected with the laser focused at the respective trial location and selecting said selected location for the focus for the laser in dependence on the signal strength metrics,
wherein the determination of the signal strength metric by the determination unit comprises mitigating against non-sample signals by relative enhancement or diminution of detected signals received in at least one selected wavelength range in comparison to detected signals received outside said at least one selected wavelength range.

According to another aspect of the present invention there is provided a Raman spectrometer comprising a laser for illuminating a sample under investigation, an auto-focusing system for focusing the laser on the sample under investigation, and a detector for detecting Raman spectra emitted in response to illumination by the laser,
wherein the auto-focusing system comprises at least one adjustable focusing element for adjusting the location of the focus of the laser, a determination unit for determining a selected location for the focus of the laser, and a controller for adjusting the adjustable focusing element to focus the laser at said selected location determined by the determination unit,
wherein the auto-focusing system is arranged under the control of software to enable determination of the selected location for the focus of the laser by: using the controller to adjust the adjustable focusing element to focus the laser at a plurality of trial locations,
receiving at the determination unit detected Raman spectra from the detector at each of said plurality of trial locations,
determining at the determination unit a signal strength metric from each detected spectrum which is representative of the strength of the Raman spectrum detected with the laser focused at the respective trial location and selecting said selected location for the focus for the laser in dependence on the signal strength metrics,
wherein the determination of the signal strength metric by the determination unit comprises mitigating against non-sample signals by relative enhancement or diminution of detected signals received in at least one selected wavelength range in comparison to detected signals received outside said at least one selected wavelength range.

This may allow auto-focusing based on the strength of the received signal whilst mitigating against non-sample signals—such as those from a container or packaging—in this specification we use “containing material” to refer to “container or packaging material”. This can help in avoiding a false signal which may lead to inaccurate focusing.

It will be appreciated that wherever in this specification there is reference to a wavelength range or ranges, this is also equivalent to a corresponding frequency range or ranges, and a corresponding wavenumber range or ranges. Thus, however a range may be defined—in terms of wavelength, frequency or wavenumber—in say software code, there will always be a corresponding wavelength range.

Determination of the signal strength metric by the determination unit may comprise relative enhancement or diminution of detected signals received in a plurality of selected wavelength ranges in comparison to detected signals received outside said selected wavelength ranges.

In some cases, diminution of detected signals may comprise blocking or setting those signals to zero. Where signals in at least one wavelength range are blocked or set to zero this can be considered as applying a mask to the spectrum.

The determination of the signal strength metric by the determination unit may comprise applying a mask to each detected spectrum to remove signals in at least one selected wavelength range.

Determination of the signal strength metric by the determination unit may comprise processing each detected spectrum with a weighting vector defining a plurality of wavelength ranges and a weighting value assigned to each wavelength range. Processing a detected spectrum with the weighting vector may comprise multiplying the spectrum in each of the plurality of wavelength ranges by the respective weighting value.

The weighting value may be selected from a range extending between a maximum value and zero. The maximum value may be 1.

The at least one selected wavelength range may be selected in dependence on user input. The at least one selected wavelength range may be determined by the auto-focusing system in dependence on user input. The at least one selected wavelength range may be directly selected by user input. The spectrometer may be arranged to accept user input for selecting the selected wavelength range.

The at least one selected wavelength range may be determined by the auto-focusing system in dependence on known properties of the sample under investigation and/or known properties of containing material of the sample under investigation.

The spectrometer may hold a library of investigation settings and be arranged to allow a user to select at least one investigation setting.

At least some of the investigation settings may be provided for selection by a user where the sample is known or expected to comprise a predetermined material or a material from a predetermined set of materials.

At least some of the investigation settings may be provided for selection by a user where a containing material in which the sample is packaged or contained is known or expected to comprise a predetermined material or a material from a predetermined set of materials.

At least some of the investigation settings may be provided for selection by a user where the sample is known or expected to comprise a first predetermined material or a material from a first predetermined set of materials and where a containing material in which the sample is packaged or contained is known or expected to comprise a second predetermined material or a material from a second predetermined set of materials.

The auto-focus system may be arranged to operate in dependence on at least one investigation setting selected by a user.

The at least one investigation setting may comprise at least one parameter for use by the determination unit in the determination of the signal strength metric.

The at least one parameter may determine or be used in determining the at least one selected wavelength range.

In a preferred embodiment the spectrometer is arranged to present to a user at least one investigation setting which is indicated by the spectrometer to be suitable for use where a sample is known or expected to comprise a first predetermined material or a material from a first predetermined set of materials and/or where a containing material in which the sample is contained or packaged is known or expected to comprise a second predetermined material or a material from a second predetermined set of materials; and
preferably wherein the determination of the signal strength metric by the determination unit comprises relative enhancement or diminution of detected signals received in at least one selected wavelength range, which range is selected in dependence on the investigation setting, in comparison to detected signals received outside said at least one selected wavelength range.

Using these ideas, for example, a predetermined weighting vector, say a mask, may be stored in the spectrometer for selection and use by a user with a particular sample type, containing material type, or sample type and containing material type combination.

In one set of embodiments a weighting vector may be determined on the spectrometer. In another set of embodiments a suitable weighting vector may be determined externally to the spectrometer—for example on a separate computer.

In each case this may be a weighting vector for one time use or a predetermined weighting vector as mentioned above for storage on the spectrometer for use as needed.

In either case the weighting vector may be machine determined or determined with user intervention, for example user selection, as part of the determination process.

In one set of embodiments the spectrometer or an external computer and associated display device is arranged under the control of software to:
display to the user a spectrum representing a Raman emission from a sample and/or a spectrum representing a Raman emission from containing material; and
accept input from the user indicating the at least one selected wavelength range to be used in the determination of the signal strength metric by relative enhancement or diminution of detected signals received in the at least one selected wavelength range in comparison to detected signals received outside said at least one selected wavelength range.

In such a case the user may choose to select for enhancement those wavelength regions where the sample displays a large Raman response and/or to select for diminution those wavelength regions where the containing material displays a small Raman response.

The Raman spectra displayed by the spectrometer or the external computer may be acquired by the spectrometer or in another way.

The spectrum representing a Raman emission from a sample and/or the spectrum representing a Raman emission from containing material may for example comprise a Raman spectrum or a processed Raman spectrum. Processing the Raman spectrum to obtain the processed Raman spectrum may comprise generating the 2^{nd} derivative of the Raman spectrum. Thus for example the user may be displayed the 2nd derivative of the Raman spectrum of a sample and/or containing material to aid in selection of the selected wavelength regions.

This can help highlight those areas with a strong Raman response as this tends to vary quickly with wavelength.

Typically the user may in effect determine a weighting vector which is a mask, such that signals in the at least one selected wavelength range are included in the determination of the signal strength metric and signals outside the at least one selected wavelength range are discarded.

In an alternative the weighting vector may be machined determined as mentioned above making use of an appropriate computer implemented method.

The weighting vector determination method may comprise the steps of analysing a spectrum representing a Raman emission from a sample and/or a spectrum representing a Raman emission from containing material.

The weighting vector determination method may comprise determining a negative mask which represents at least one wavelength range where the containing material has a Raman response above a threshold and setting the weighting vector to exclude said at least one containing material wavelength range from the determination of the signal strength metric.

The weighting vector determination method may comprise determining a positive mask which represents at least one wavelength range where the sample has a Raman response above a threshold and setting the weighting vector to include said at least one sample wavelength range in the determination of the signal strength metric.

The weighting vector determination method may comprise generating final mask as the weighting vector by combining the negative mask and the positive mask so that the weighting vector is set to include said at least one sample wavelength range in the determination of the signal strength metric but to exclude from said at least one sample wavelength range any wavelengths which are also in the at least one containing material wavelength range.

According to another aspect of the invention, there is provided a weighting vector determination method for use in a spectrometer as defined above comprising the steps of:
determining a negative mask which represents at least one wavelength range where the containing material has a Raman response above a threshold and setting the weighting vector to exclude said at least one containing material wavelength range from the determination of the signal strength metric;
determining a positive mask which represents at least one wavelength range where the sample has a Raman response above a threshold and setting the weighting vector to include said at least one sample wavelength range in the determination of the signal strength metric; and
generating final mask as the weighting vector by combining the negative mask and the positive mask so that the weighting vector is set to include said at least one sample wavelength range in the determination of the signal strength metric but to exclude from said at least one sample wavelength range any wavelengths which are also in the at least one containing material wavelength range.

The weighting vector determination method may comprise acquiring Raman spectra for a sample and a containing material, computing the second derivative of the sample spectrum, and orthogonalizing the second derivative of the sample spectrum to the containing material spectrum.

According to another aspect of the invention, there is provided a weighting vector determination method for use in a spectrometer as defined above comprising the steps of:
acquiring Raman spectra for a sample and a containing material,
computing the second derivative of the sample spectrum, and
orthogonalizing the second derivative of the sample spectrum to the containing material spectrum.

The determination of the signal strength metric may comprise summing the magnitude of the spectrum over a predetermined wavelength range.

The auto-focusing system may be arranged to select said selected location for the focus for the laser in dependence on where the signal strength metric indicates a maximum detected Raman signal.

The auto-focusing system may be arranged to select said selected location for the focus for the laser to be the respective trial location which yielded a signal strength metric indicating a maximum detected Raman signal.

The auto-focusing system may be arranged under the control of software to select said selected location for the focus for the laser by identifying a location which would be expected to yield a signal strength metric indicating a maximum detected Raman signal by interpolation using the signal strength metric values corresponding to the respective trial locations.

The auto-focusing system may be arranged under the control of software to fit a function in terms of laser focus location to the signal strength metric values corresponding to the respective trial locations and use the fitted function to determine the selected location for the laser focus.

Using the fitted function to determine the selected location for the laser focus may comprise identifying from the function a laser focus location which would be expected to yield a signal strength metric indicating a maximum detected Raman signal.

Using the fitted function to determine the selected location for the laser focus may comprise identifying from the function a laser focus location which corresponds to a maximum in signal strength metric indicated by the function.

The determination of the signal strength metric may comprise processing each detected spectrum to mitigate against baseline effects.

The determination of the signal strength metric may comprise determining the second derivative of each detected spectrum.

This is an example of a processing step that may serve to mitigate against baseline effects and can help minimise the effect of variations in intensity which vary slowly with wavelength such as fluorescence whilst preserving or enhancing variations in intensity which vary quickly with wavelength such as typical Raman spectra.

The step of determining the second derivative may be carried out before the process of relative enhancement or diminution of detected signals received in a plurality of selected wavelength ranges in comparison to detected signals received outside said selected wavelength ranges.

Thus for example, determination of the signal strength metric by the determination unit may comprise first determining the second derivative of each detected spectrum and second processing the processed spectrum with a weighting vector defining a plurality of wavelength ranges and a weighting value assigned to each wavelength range. Determination of the signal strength metric by the determination unit may third comprise taking the absolute value at each wavelength of the resulting spectrum and summing these absolute values.

The auto-focusing system may be arranged under the control of software to determine an initial location range in which the plurality of trial locations should be chosen to fall before commencing determination of the selected location for the focus of the laser.

Typically the initial location range will correspond to only a part of the range of focus positions to which the focusing system can focus.

This can help increase the speed and/or accuracy of determining the selected location for the focus of the laser. It can allow the plurality of trial locations to be more closely spaced than if this initial location range is not determined. The auto-focusing system can in effect carry out a first coarse auto-focus operation followed by a fine auto-focus step.

The initial location range may be determined in dependence on user input.

In a preferred embodiment the auto focusing system is arranged to determine the initial location range by:
using the controller to adjust the adjustable focusing element to focus the laser at a plurality of initial locations,
receiving at the determination unit detected Raman spectra from the detector at each of said plurality of initial locations,
determining at the determination unit a signal strength metric from each detected spectrum which is representative of the strength of the Raman spectrum detected with the laser focused at the respective initial location and selecting said initial location range in dependence on the signal strength metrics.

The determination of the signal strength metric by the determination unit when selecting the initial location range may comprise mitigating against non-sample signals by relative enhancement or diminution of detected signals received in at least one selected wavelength range in comparison to detected signals received outside said at least one selected wavelength range.

That is to say, in some cases, the same method for determining the signal strength metric may be used when selecting the initial location range as when selecting the selected location for the laser focus, but in other cases a different, possibly simpler, method may be used when selecting the initial location range.

The auto-focusing system may be arranged for moving the adjustable focusing element relative to a remainder of the spectrometer.

The at least one adjustable focusing element may comprise a movable objective lens for focusing the beam of the laser onto a sample.

The auto-focusing system may comprise a drive mechanism for moving the movable objective lens along the optical axis of the lens relative to a remainder of the spectrometer.

The spectrometer may comprise illumination optics for directing the beam of the laser to the sample, and collection optics for collecting a Raman emission from the sample and directing this towards the detector.

The illumination optics may comprise the objective lens. The collection optics may comprise the objective lens.

The spectrometer may comprise a screen for displaying information to a user. For example this screen may be an LCD screen and may for example display menu options for use in controlling the spectrometer and/or may display data concerning investigations made using the spectrometer.

The screen may be mounted for movement between a first position for use when the spectrometer is used in a first orientation and a second position for use when the spectrometer is used in a second orientation.

The first orientation may be an orientation where the sample is to be located below the spectrometer. The second orientation may be an orientation where the sample is to be located above the spectrometer.

The screen may be movable between a state where it faces towards the same direction as the laser beam leaves the spectrometer in use and a state where it faces towards an opposite direction.

The screen may be hingedly mounted to a main body of the spectrometer.

The screen may be flush with the main body in one state and project from the main body in another state. Where the screen projects from the main body, the screen may help support the spectrometer in use.

The spectrometer may comprise a computer for controlling overall operation of the spectrometer. The determination unit may comprise the computer operating under control of software. The controller may comprise the computer operating under control of software.

According to another aspect of the present invention there is provided a Raman spectrometer arrangement comprising:
a Raman spectrometer as defined above, and
a spectrometer accessory which is mountable on the spectrometer.

The spectrometer arrangement may comprise an interlock arrangement for controlling operation of the laser wherein the interlock arrangement enables operation of the laser when the accessory is mounted on the spectrometer and disables operation of the laser when the accessory is not mounted on the spectrometer.

The accessory may comprise a sample holder and the auto-focusing system may be arranged for moving the adjustable focusing element relative to the sample holder.

According to another aspect of the present invention there is provided a method of auto-focusing a Raman spectrometer comprising a laser for illuminating a sample under investigation, an auto-focusing system for focusing the laser on the sample under investigation, and a detector for detecting Raman spectra emitted in response to illumination by the laser,
wherein the auto-focusing system comprises at least one adjustable focusing element for adjusting the location of the focus of the laser, a determination unit for determining a selected location for the focus of the laser, and a controller for adjusting the adjustable focusing element to focus the laser at said selected location determined by the determination unit, and wherein the auto-focusing method comprises the steps of:
using the controller to adjust the adjustable focusing element to focus the laser at a plurality of trial locations,
receiving at the determination unit detected Raman spectra from the detector at each of said plurality of trial locations,
determining at the determination unit a signal strength metric from each detected spectrum which is representative of the strength of the Raman spectrum detected with the laser focused at the respective trial location and selecting said selected location for the focus for the laser in dependence on the signal strength metrics,
wherein the determination of the signal strength metric by the determination unit comprises mitigating against non-sample signals by relative enhancement or diminution of detected signals received in at least one selected wavelength range in comparison to detected signals received outside said at least one selected wavelength range.

Each of the optional features following each of the aspects of the invention above can be equally applicable as an optional feature in respect of each of the other aspects of the invention and could be written after each aspect with any necessary changes in wording. The optional features are not written after each aspect merely in the interests of brevity.

### BRIEF DESCRIPTION OF DRAWINGS

Embodiments of the present invention will now be described, by way of example only, with reference to the accompanying drawings in which:

FIG. 1 schematically shows a portable Raman spectrometer;

FIG. 2 schematically shows components of the Raman spectrometer shown in FIG. 1;

FIG. 3 shows the Raman spectrometer of FIG. 1 with a first accessory mounted on the spectrometer to form a spectrometer arrangement;

FIG. 4 schematically shows the spectrometer of FIG. 1 with a second accessory mounted thereon to form a spectrometer arrangement;

FIG. 5 schematically shows the spectrometer of FIG. 1 with a third accessory mounted thereon to form a spectrometer arrangement;

FIG. 6 is a section view of the spectrometer arrangement shown in FIG. 3;

FIG. 7 is a section view of the spectrometer arrangement shown in FIG. 4;

FIG. 8 is a section view of the spectrometer arrangement shown in FIG. 5 in a first configuration for use with the spectrometer arrangement in a first orientation;

FIG. 9 is a section view of the spectrometer arrangement shown in FIGS. 5 and 8 in a second configuration for use with the spectrometer arrangement in a second orientation;

FIG. 10 shows a flow chart illustrating a process for auto-focusing which is followed by the spectrometer shown in FIGS. 1 to 9;

FIG. 11 shows an example plot of merit function values and fitting functions defined in the auto-focusing process of FIG. 10;

FIG. 12 is a flow chart showing in more detail the calculation of a merit function to measure quality of focus at each trial focus position in the auto-focusing process of FIG. 10;

FIG. 13 is a plot showing an example of Raman spectrum for a sample and an example Raman spectrum for packaging;

FIG. 14 is an example plot illustrating a mask which may be used in the auto-focus processes shown in FIGS. 10 and 12;

FIG. 15 is a flow chart showing a process for manually determining a weighting vector or mask for use in a process for determining a merit function using a process of the type shown in FIG. 12;

FIG. 16 shows a flow chart for a process for automatically determining a weighting vector or mask for use in a process for determining a merit function using a process of the type shown in FIG. 12;

FIG. 17 shows plots relating to the process for determining a weighting vector or mask according to the process shown in FIG. 16;

FIG. 18 shows an alternative automatic process for determining a weighting vector for use in a process of the kind illustrated in FIG. 12 for determining a merit function; and

FIG. 19 shows a plot illustrating a weighting vector of a type which may be generated using a process of the type shown in FIG. 18.

### DETAILED DESCRIPTION

It has been recognised and appreciated by the applicant that a single sampling geometry or instrument arrangement cannot conveniently accommodate all types of sampling or all types of samples which are of interest. Conventional Raman spectrometers are desktop instruments and samples must be brought to the location of the instrument. The applicant has recognized and appreciated that it would be beneficial to have a system which could be used in a variety of modes, including a desktop mode (or, equivalently, a tabletop mode), whilst being portable and also usable in other modes, for example, a hand-held mode.

The applicant has further recognized and appreciated that it would be beneficial to have one or more accessories that may be mounted to a Raman spectrometer to operate in the different modes. In particular, a desktop-based accessory that is capable of being used in a first orientation where the accessory is in contact with the flat surface of a desk or table with the accessory mounted on the Raman spectrometer such that the Raman spectrometer is located on the other side of the accessory from the desk or table, and a second orientation where the Raman spectrometer is in contact with the flat surface of the desk or table with the accessory mounted on the Raman spectrometer such that the accessory is located on the other side of the Raman spectrometer from the desk or table. To enable the use of the desktop-based accessory in both orientations, a drawer of the accessory that is configured to hold the sample to be analysed is further configured to be inserted in the accessory in two different orientations: a first orientation where the flat surface of the drawer on which the sample is to be placed is oriented upward when the accessory is in contact with the table and a second orientation where the flat surface of the drawer on which the sample is to be placed is oriented upward when the Raman spectrometer is in contact with the table.

By providing an accessory that may be used in multiple orientations, a single accessory may be used to sample multiple different samples. In particular, there may be some samples that are better analysed from below and other samples that are better analysed from above. Both types of samples may be analysed using this type of desktop-based accessory.

The applicant has further recognized and appreciated that one challenge in developing a Raman spectrometer capable of operating in multiple modes is that a relatively high-powered laser is typically required to obtain useful Raman spectra. For example, conventional Raman spectrometers include a Class IIIB laser, which raise a number of safety concerns for the user of such an instrument. The applicant has recognized and appreciated that to increase the safety of the user, it is desirable for an overall device or instrument to be a Class I device. In additional to being considered “safe,” such devices can be used in a wider range of circumstances than class IIIB devices and, for example, with fewer other safety measures in place and/or less user training.

Accordingly, some embodiments are directed to Raman spectrometer devices that may be operated in a variety of modes while being a class I device.

To perform Raman spectroscopy, a laser beam is typically focused to a tight spot size on a sample in order to obtain good results. The inventors have recognized and appreciated that, in various situations, such as with a handheld Raman spectrometer, but not restricted to such circumstances, it may not be possible to guarantee a constant distance between an optical system of the spectrometer and the sample. Accordingly, the inventors have further recognized and appreciated that an adjustable focus system is useful to include in the Raman spectrometer and that usability of the Raman spectrometer may be further improved if focus can be carried out automatically, that is to say, if the Raman spectrometer is provided with an auto-focus system.

One approach to an auto-focus system of a Raman spectrometer would be to vary the focus of the system whilst Raman signals are acquired and determining a selected focus position of a lens of the optical system based on maximizing the Raman signal. The inventors have recognized and appreciated that such a simple approach to autofocus may not result in the best Raman signal.

As mentioned above, a sample may be contained in a packaging material or held in a container such that the Raman spectra need to be obtained through the containing material. In such a case, the inventors have recognized and appreciated that the naïve autofocus approach discussed above may lead to errors because the material of the packaging or container may Raman scatter the incident light. As a result, the simple autofocus mechanism may lead to incorrect focusing on the packaging material or the material of the container, rather than the sample.

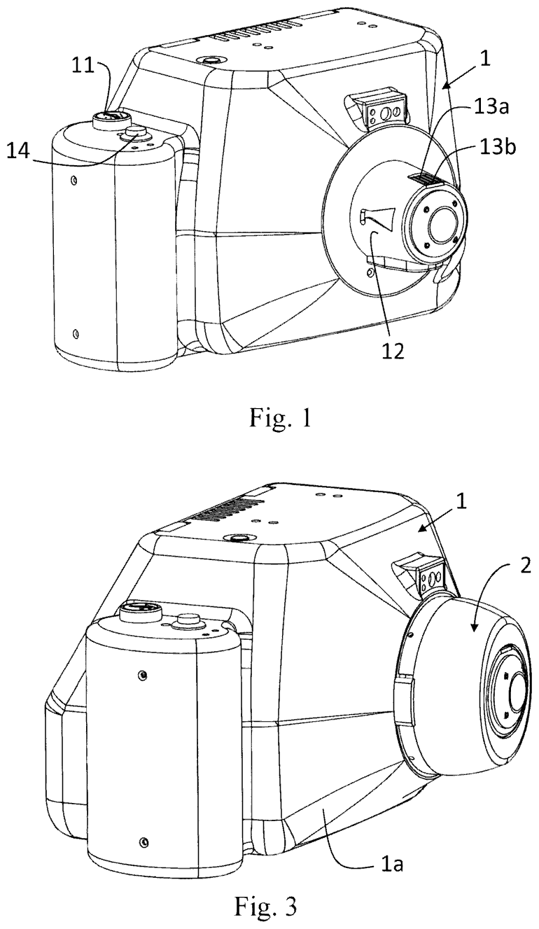

FIG. 1 schematically shows a portable Raman spectrometer 1 which is arranged for carrying out Raman spectroscopy in multiple modes with a range of sample types. This spectrometer 1 may be used in a number of different ways including in a hand-held mode as will be described in more detail below.

The detailed functioning and operation of Raman spectrometers for use in Raman spectroscopy in the field of analysing samples is well known and will not be described in detail here.

At a very general level in Raman spectroscopy a sample is illuminated with a highly focused laser of a suitable wavelength/frequency (for example a near infrared laser, though lasers with other emission spectra may be used). As a result of the illumination, some materials, particularly those materials with organic chemical components, will inelastically scatter the incident laser light in an interaction known as Raman scattering. The Raman scattered light can be collected and analysed, resulting in a Raman emission spectrum. The Raman emission spectrum includes wavelengths that are shifted from the wavelength of the illuminating laser. The shift in wavelength of the scattered light is caused by the laser radiation interacting with different virtual energy states, due to vibrational modes and other effects, that exist in the sample being investigated.

Photons from the laser illumination having a first energy are absorbed and emitted at a different energy following this interaction with the vibrational states and so on in the sample. The different photon energies correspond to different wavelengths/frequencies.

The resulting Raman emission spectrum that is obtained is characteristic of a particular material or materials that are present in the sample. Thus, by considering observed Raman spectra, one or more materials present in the sample can be identified. The Raman scattering effect is typically small resulting in a low signal-to-noise ratio, where a high noise level results from the illuminating radiation simply (elastically) scattering off the sample. Accordingly, a spectral filter is typically included in the Raman spectrometer to remove light at the illumination wavelength.

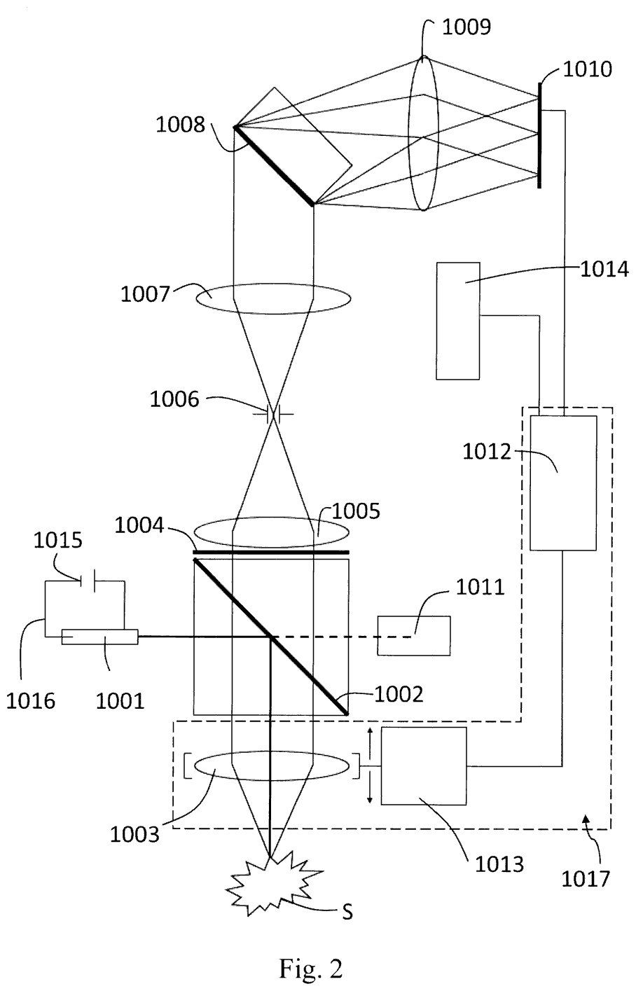

FIG. 2 schematically shows some of the internal components of the spectrometer shown in FIG. 1 which are housed in a housing 1a of the spectrometer 1. The spectrometer 1 comprises a laser 1001 the beam of which is directed via a dichroic mirror 1002 through an objective lens 1003 to a sample S. This laser light (which in some embodiments may be of a near infrared frequency) interacts with the sample S and is scattered. Scattered radiation is collected by the objective lens 1003 and passes through the dichroic mirror 1002. This collected light then meets a Rayleigh filter 1004. In some embodiments, the Rayleigh filter 1004 may be a notch filter tuned to the wavelength of the laser, that is configured to filter out light which has been elastically scattered by the sample rather than inelastically scattered. In some embodiments, the Rayleigh filter 1004 may be a long-pass filter that blocks the higher frequency laser light, but passes the longer wavelength Raman scattered light. In other words, Raman scattered light is allowed to continue through the spectrometer 1 towards a detector 1001 while laser light is blocked by the filter 1004 and prevented from reaching the detector 1001.

The filtered light passes through a spectrometer coupling lens 1005 through the spectrometer entrance slit 1006 and is directed by a spectrometer collimating lens 1007 onto a diffraction grating 1008. The diffraction grating 1008 is arranged so that light of different wavelengths/frequencies will be diffracted at a different angle. Thus, the output of the diffraction grating 1008 suitably focused by a spectrometer focusing lens 1009 arrives on the detector of the spectrometer at a spatial position which is dependent on the wavelength of the light. In the embodiment illustrated in FIG. 2, the detector 1010 is a linear CCD array but other types of spatially resolving detectors may be used. Since the diffraction grating 1008 spatially separates the light based on wavelength, the detector 1010 can directly measure the spectrum of the Raman scattered light. The output from the detector 1010, which may include electrical signals, is provided to a controller 1012, which may be implemented as a computer under the control of software. The computer may comprise a processor, tangible non-transitory memory and a data storage device. The output may be stored and/or analysed by the controller 1012. The spectrometer 1 may also include a beam dump 1011 which absorbs any portion of the laser beam 1001 that passes through the dichroic mirror 1002.

The spectrometer 1 further comprises a focusing arrangement 1013 including drive means, such as a translation stage, for driving the objective lens 1003 along its optical axis for focusing the laser beam on the sample S. The focusing arrangement 1013 operates under the control of the controller 1012 and together with the objective lens 1003 these form a focusing system 1017.

The focusing system will be described in more detail further below.

The spectrometer 1 may also include a user display screen 1014 that also operates under the control of the controller 1012. The display screen 1014 may show a visual indication of the output from the detector 1010. For example, a graph of the Raman spectrum of the sample S may be displayed. A variety of user options may also be displayed by the display screen 1014, such as options for controlling the operation of the focusing system 1017 and the laser 1001. Further the user display screen 1014 may be a touch screen device used for accepting user inputs to control operation of the spectrometer 1.

Note that the sectional views of the spectrometer 1 shown in FIGS. 6 to 9 (described in more detail below) show the internal components of the spectrometer 1 in more detail. A detailed description of these components is omitted as it is not relevant to the present invention. However, FIG. 6 includes reference numerals to indicate at least some of these components which are also shown schematically in FIG. 2. Not all of the components described in relation to FIG. 2 can be seen in FIGS. 6 to 9 as each figure is only a 2-D section in each case.

In some embodiments, the laser 1001 is a diode laser and caused to operate by a laser current provided from a power source 1015 via an electrical conduction path 1016. However, other types of lasers may be used, such as solid state, gas, or dye lasers, may be used. In some embodiments the power source 1015 comprises one or more battery.

In some embodiments, the spectrometer 1 is provided with at least two interlock mechanisms for preventing accidental operation of the laser 1001 and/or operation of the laser 1001 in unsafe circumstances. A first interlock mechanism comprises a key operated switch 11 provided on the spectrometer as shown in FIG. 1. This switch 11 is configured to cause a break in the electrical conduction path 1016 when in an off position such that operation of the laser 1001 is prevented without the key switch 11 turned to an on position by insertion of a suitable key. Thus, the first interlock mechanism controls an overall operation of the device.

In some embodiments, the spectrometer 1 may include an acquire spectrum button 14 which is depressable by a user when it is desired to acquire a spectrum, similar to a user taking a photograph with a camera. Depressing the button 14 will only cause operation of the laser 1001 and acquisition of a spectrum if the interlocks are all in the laser enabled state. In some embodiments, button 14 may be omitted and acquisition of the Raman spectrum may be initiated by the controller 1012 or by user input to the display screen 1014.

A second interlock mechanism is provided in the form of interaction between the spectrometer 1 and a respective accessory 2, 3 and 4 (as shown in FIGS. 3 and 6, FIGS. 4 and 7, and FIGS. 5, 8 and 9 respectively), each accessory configured to be mounted on the spectrometer 1.

In alternatives, some aspects of the present invention may be embodied in a spectrometer of a different type that does not require a separate accessory to function. Such a spectrometer may again be a hand held spectrometer.

As shown in FIG. 1 the spectrometer 1 comprises an accessory mounting portion 12 which in some embodiments is turret shaped. A pair of contacts 13a, 13b are provided on the accessory mounting portion 12. These contacts 13a and 13b are a part of the electrical conduction path 1016. Electrical current, e.g., the laser current, may flow from the power source 1015 to the laser 1001 when the first contact 13a is electrically connected to the second contact 13b, whereas when the contacts 13a, 13b are not connected to each other, the conduction path 1016 is interrupted, thereby preventing the laser current from flowing and preventing operation of the laser 1001.

FIGS. 3 and 6 show a first accessory 2 mounted on the spectrometer 1. The first accessory 2 may be an interlock collar which is configured to allow operation of the spectrometer when the collar 2 is correctly fitted on the accessory mounting portion 12. This is achieved because the collar 2 comprises an electrical conductor portion 21 which forms part of the conduction path 1016 for allowing powering of the laser 1001 when the collar 2 is correctly mounted on the spectrometer 1. The first accessory 2 is arranged so that, when correctly fitted, the conductor portion 21, connects the first contact 13a to the second contact 13b on the accessory mounting portion 12, thereby allowing the laser current to flow from the power source 1015 to the laser 1001.

Based on the foregoing, in some embodiments the spectrometer 1 cannot function without the accessory 2 in place, but with the accessory 2 in place the spectrometer 1 can function. This leads to an overall spectrometer arrangement shown in FIG. 3 which can be used in a hand-held mode such that the spectrometer arrangement may be taken to the location of a sample to be analysed, the spectrometer may be positioned in relation to the sample, and a spectrum may be acquired by a user operating the acquire spectrum button 14. In this hand-held mode, in response to the user pressing the button 14 to take a spectrum, the controller 1012 may control the focusing arrangement 1013 to cause movement of the objective lens 1003 to automatically focus the laser beam onto the sample.

In the hand-held mode of operation, that is to say with the spectrometer arrangement shown in FIG. 3, whilst the presence of a collar 2 is required to allow the spectrometer 1 to operate, the accessory 2 does not provide any additional safety via shielding or obscuring of the laser beam. Thus, in the spectrometer arrangement as shown in FIG. 3, if the laser is a class IIIB laser, the overall spectrometer arrangement will also be a class IIIB device. Consequently, other safety precautions, training, and controlled areas etc, may be required when using the device in this configuration. However, these inconveniences are counteracted by the flexibility and convenience of being able to use the device in the hand-held mode.

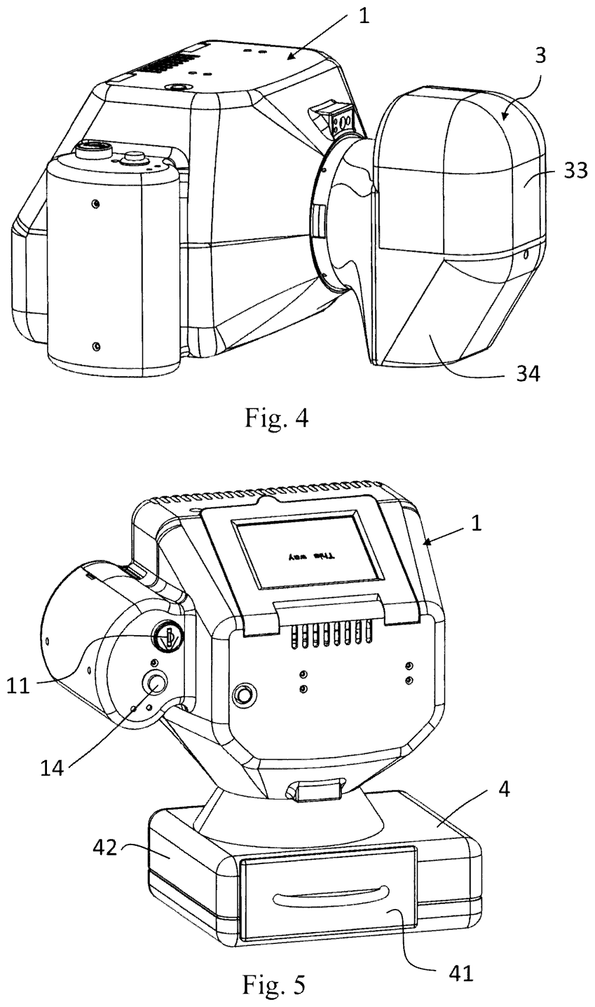

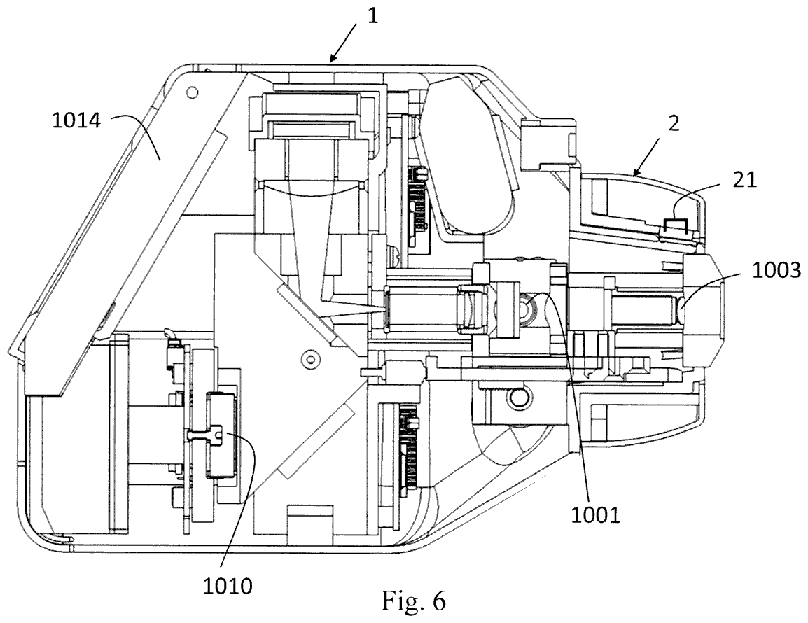

FIGS. 4 and 7 show the spectrometer 1 with a second accessory 3 mounted thereon. In some embodiments, this accessory 3 comprises a conductor portion 31 for use in making the conduction path 1016 complete when the accessory 3 is mounted on the spectrometer 1. This may be achieved by the conductor portion 31 having contact terminals configured to physically contact with and electrically connect to the contacts 13a, 13b provided on the accessory mounting portion 12 of the spectrometer 1.

The second accessory 3 is configured to hold a vial which in turn holds a sample to be analysed. The accessory 3 includes a sample holding portion 32 in the form of a vial holding recess. The second accessory 3 also comprises a lid or door portion 33 which may be removably mounted on the main body 34 of the accessory 3. In this embodiment the lid 33 is held in place with a magnetic catch (not shown). In some embodiments, the lid or door portion 33 may not be removably mounted on the main body 34, but instead may be connected to the main body 34 using a hinge that allows the lid or door portion 33 to open without being completely removed from the main body 34.

When the lid portion 33 is open or removed access can be gained to the sample holding portion 32 so that a vial including a sample can be deposited in the accessory 3 or removed therefrom. In some embodiments, the conductor portion 31 provided in the accessory 3 also includes an accessory switch 35 which will adopt an open state when the lid 33 is removed and a closed state when the lid portion 33 is correctly mounted on the main body 34. Thus, this switch 35 can serve as a third interlock mechanism to interrupt the conductor portion 31 so as to prevent a flow of laser current through the conductor portion 31 between the first and second contacts 13a, 13b on the spectrometer mounting portion 12. As such, when the accessory 3 is mounted on the spectrometer 1 and the lid portion 33 is closed, the switch 35 is closed and laser current can flow through the conductor portion 31 of the second accessory 3 so enabling operation of the laser 1001. On the other hand, when the lid portion 33 is open, flow of laser current is interrupted due to the accessory switch 35 being open. Consequently, the accessory 3 in effect blocks user viewing of the laser beam first by its presence (or the lack thereof) and second by the fact that even with the accessory 3 in place, if the lid portion 33 is open, the laser current will be interrupted. In some embodiments, for example as shown in FIG. 7, even if the laser current were not interrupted in this state, then looking directly down the line of the laser beam is prevented by the structure of the accessory 3 itself.

As a result, the spectrometer arrangement using the second accessory 3 can be categorized as a Class 1 laser device and used appropriately despite including a laser of a higher class level (e.g., class IIIB).

In some embodiments, with the second accessory 3 mounted on the spectrometer 1 the sample will be at a known location. That is to say the sample holding portion 32 holds every vial in the same location each time a vial is placed in the accessory 3. Therefore, the spectrometer may be used in a fixed-focus mode. In the fixed-focus mode, the controller 1012 controls the focusing arrangement 1013 to move the objective lens 1003 to a predetermined focus position.

In some embodiments, the second accessory 3 is configured to accept vials of more than one size. For example, the second accessory 3 may include an adjustment member 36 that can be moved (e.g., by sliding) towards and away from a wall of the accessory which faces the spectrometer for altering the size of the sample holding portion 32. In some embodiments, the wall may include the lid or door portion 33. Based on the foregoing, the controller 1012 may control the focusing system 1013 to adjusted the focal length of the objective lens 1003 based on the size of the vial located in the sample holding location 32. However, in other embodiments, such a focal length adjustment is not used since sampling may be set to take place at a location which would be within the volume of any of the different size vials that may be accommodated in the sample holding portion 32.

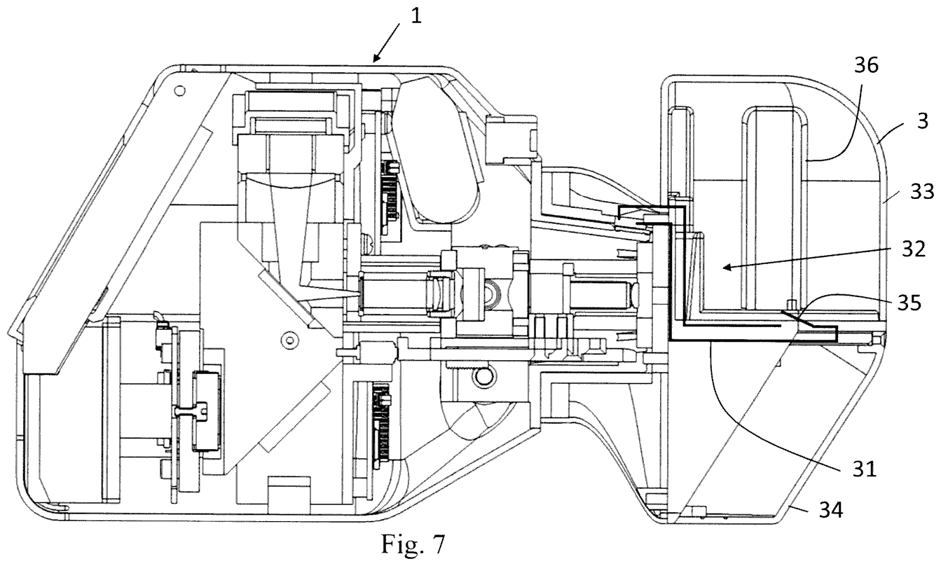

FIGS. 5, 8 and 9 show a third accessory 4 mounted on the spectrometer 1. The third accessory 4 is configured to accept samples to be analysed. The samples, in some embodiments, may be solid samples, for example a sample held in a petri dish. In some embodiments, samples may be placed directly onto a sample holder of the third accessory 4.

It is noted that both the second accessory 3 and third accessory 4 are arranged to allow the use of the spectrometer arrangement as a desktop device, not a hand-held device—although still portable.

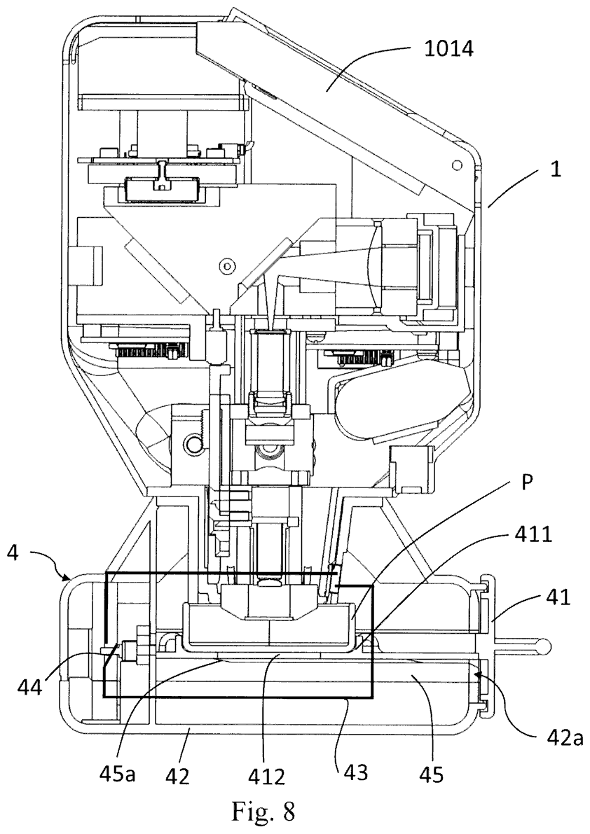

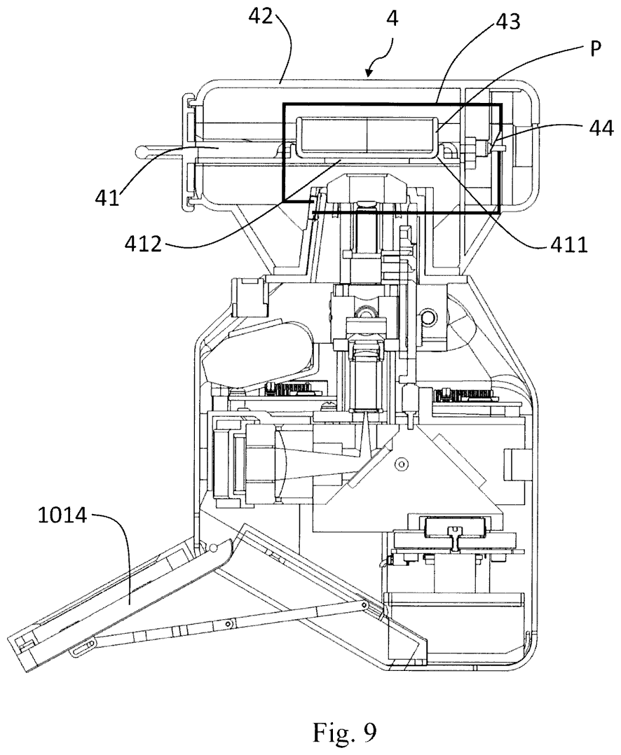

The third accessory 4 is configured for use with the spectrometer 1 in two distinct orientations. The first of these orientations is shown in FIGS. 5 and 8 and the second of the orientations is shown in FIG. 9.

In the first orientation the accessory 4 is located below the spectrometer 1 such that the spectrometer arrangement will sit on a desk or table on the accessory 4 as a base. In this first orientation, the accessory 4 is in physical contact with the desk/table. In the second orientation, as shown in FIG. 9, the accessory 4 is located above the spectrometer 1 with the spectrometer acting as a base that is in physical contact with the desk/table. In this second orientation, as shown in FIG. 9, the display screen 1014 can be rotated about a hinge outwards away from a main body of the spectrometer 1. The outward rotation of the display screen 1014 provides at least two functions. First, the display screen 1014 remains visible to a user with the device in this second orientation. Second, the display screen 1014 when hinged out helps to stabilise the spectrometer arrangement and acts as part of a base for the spectrometer 1.

In some embodiments, the third accessory 4 comprises a drawer 41 which is slidingly received in a main body 42 of the accessory 4. The main body 42 has an opening 42a for accepting the drawer 41. The drawer 41 may be completely removed and flipped over for use in the alternative orientation. In some embodiments, the drawer 41 acts as a sample holding portion. In some embodiments, the drawer 41 includes a petri dish receiving location 411 that may be defined by a rim that defines a region in which a petri dish P carrying a sample can be located. More generally the drawer comprises a flat surface configured to receive a sample.

In both the orientations of the accessory 4 shown in FIGS. 8 and 9, the drawer 41 is oriented so that the petri dish receiving location 411 is facing upwards in use. Accordingly, in the first orientation shown in FIG. 8, the receiving location 411 is directed towards the spectrometer 1 whereas in the second orientation as shown in FIG. 9 the receiving location 411 is directed away from the spectrometer 1. As such, in the first orientation shown in FIG. 8, there may be no material between a sample carried in the petri dish P (or directly on the drawer 41) but the precise location of the upper surface of this sample may be unknown. Consequently, in some embodiments, in the orientation shown in FIG. 8 the spectrometer 1 may be operated in an autofocus mode where the focus arrangement 1013, under the control of the controller 1012, moves the objective lens 1003 until focus is obtained.

On the other hand, in the orientation shown in FIG. 9 the location of the sample will be known because the sample is located at the base of the petri dish P (or directly on the drawer 41). Therefore, a fixed focus mode may be used by the spectrometer 1. In some embodiments, the position of the fixed focus may be determined based on the nature of the accessory which has been placed on the device. This may be based on detection by the device or on input by the user or some combination thereof. In the orientation shown in FIG. 9 there is the benefit that the focusing location will be known and fixed but there is a disadvantage that there will be material between the sample and the spectrometer. This material may be the base of the petri dish P and/or material in a window 412 provided in the drawer 41 through which the laser illumination and any Raman emission will pass. Note that in some embodiments rather than a window 412 of a material which is at least partly transparent to the frequencies of interest (e.g., the illumination frequency of the laser 1001 and the frequencies of the Raman scattered light), the window may be in the form of an opening provided in a drawer at a suitable location below the petri dish receiving region 411. However, the provision of such an opening carries with it a risk of material falling through the drawer and onto the spectrometer. Whilst this is undesirable it perhaps can be tolerated in some cases since once the accessory 4 is removed from the spectrometer 1, the spectrometer may be suitably cleaned.

In some embodiments, the third accessory 4 comprises a conductor portion 43 configured to be in physical contact with the contacts 13a, 13b on the accessory mounting portion 12 when the third accessory 4 is correctly mounted on the spectrometer 1, thereby forming a part of the conduction path 1016 for carrying laser current from the power source 1015 to the laser 1001. In some embodiments, the conductor portion 43 provided in the third accessory 4 comprises an accessory switch 44 which when in an open state interrupts the current flow path through the conduction portion 43 so disabling the laser 1001 even when the third accessory 4 is mounted on the spectrometer 1. Accordingly, the accessory switch 44 may act as a fourth interlock mechanism. In some embodiments, the accessory switch 44 is operated by the drawer 41. When the drawer 41 is in a closed position, which in this case corresponds with it being fully inserted in the main body 42 of the accessory 4 with the petri dish receiving location 411 aligned with the spectrometer 1, the accessory switch 44 is in a closed state completing the conduction portion 43 and hence enabling operation of the laser 1001. However, when the drawer 41 is moved away from this closed position or completely absent, the accessory switch 44 will move to the open state causing a break in the conductive path 1016 and disabling operation of the laser 1011.

In some embodiments, the accessory switch 44 may be omitted. The arrangement of the main body 42 and drawer 41 may be sufficient to ensure that even when the drawer is open, viewing of the laser beam is impossible.

In some embodiments, the drawer 41 may be arranged to run on at least one runner 45 provided in the main body 42 of the accessory 4. The runner 45 may comprise at least one ramp portion 45a for raising the drawer 41 up to an operative level as the drawer 41 is closed whilst allowing the drawer 41 to run at a lower level away from the closed position to improve clearance between the drawer 41 and the spectrometer 1 during insertion and retraction of the drawer 41.

In some embodiments the spectrometer arrangement comprises a fiber for coupling the laser to the sample.

In FIG. 2 the sample S is indicated as a free and unenclosed sample, however as mentioned above, in some embodiments a sample for which it is desired to obtain a Raman spectrum may be contained in some way or another such that the Raman spectrum needs to be acquired through material of that containment. Thus, for example, the sample S may be provided within packaging or may be held in a sample holder of a type where the Raman spectrum is acquired through a wall of the container. If one considers a hand-held mode of use of the spectrometer, it may be desired to obtain a Raman spectrum of a sample which is contained in packaging, say, where this packaged sample is being checked during a delivery process as it arrives at or leaves a factory, as it passes through a customs environment, or so on. In another scenario, such as those described above, the sample may be held in a sample holder such as a vial or petri dish and the situation is such that the Raman spectrum is acquired through a wall of that petri dish, vial, or so on.

In some embodiments, the focusing arrangement 1013 together with the controller 1012 in the present spectrometer is configured to perform an autofocusing technique at least when the sample S is contained in such a container or packaging as well as being effective when there is no such intervening containing material.

In some embodiments, the autofocusing is achieved by the controller 1012 and focusing arrangement 1013 acting together as an autofocusing system 1017 with the objective lens 1003 acting as an adjustable focusing element which is able to adjust the location of the focus of the laser 1001. The controller 1012 acts as a determination unit for determining a selected location for the focus of the laser and the focusing arrangement 1013 and the controller 1012 adjust the position of the objective lens 1003 to focus the laser at the selected location.

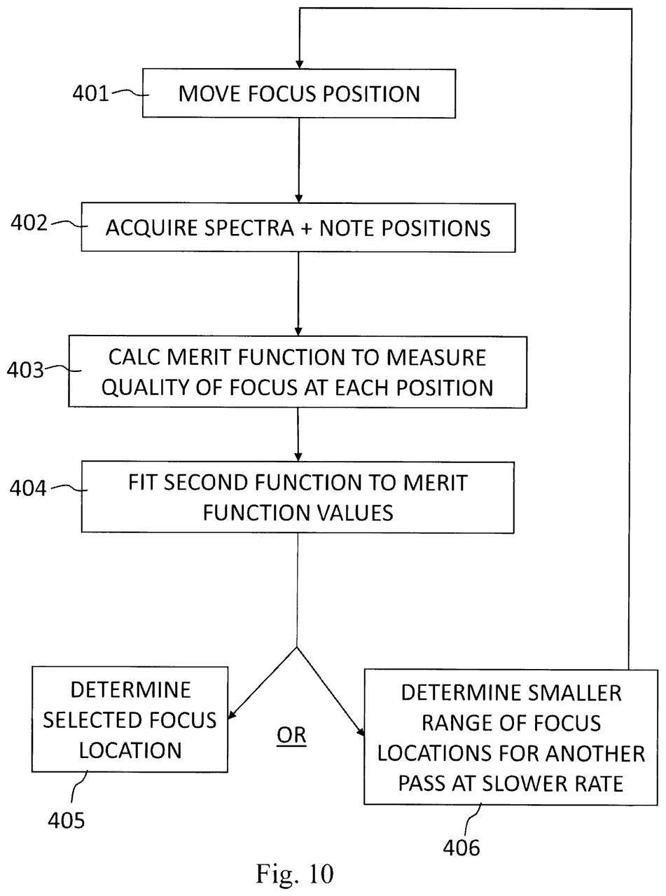

An example embodiment of a process for autofocusing the spectrometer on the sample S as performed by the focusing system 1017 is illustrated in the flow chart shown in FIG. 10.

At act 401, the location of the focus of the laser light from the laser 1001 is moved through a range of focus positions by moving the objective lens 1003 with the focusing arrangement 1013. At act 402 the spectrometer 1 acquires a Raman spectrum at a plurality of different lens positions, moving the focus position of the laser light to different positions. In some embodiments, the controller 1012 records the position of the lens 1003 at each position where the spectra are acquired.

At act 403, the controller 1012 calculates a merit function to measure the quality of focus at each position where a spectrum was acquired.

At act 404, a second function is fitted to the merit function values obtained at act 403. In some embodiments, a selected focus location may be determined from a first iteration or the process may be repeated. If a selected focus location is to be determined this is carried out at act 405 by selecting a location for the focus based on the second function of act 404. In some embodiments, the selected focus is selected to correspond to the focus position where the second function fitted to the merit function has a maximum value. If the controller 1012 determines that a second iteration is to be performed, then at act 406 a smaller range of focus locations is determined from the fitted function and a second pass through the process of FIG. 10 is performed whilst moving the objective lens 1003 at a slower rate, thereby collecting more Raman spectra within the smaller range of focus positions than were acquired during the first iteration. In some embodiments, repeating the process results in a more accurate determination of a selected focus position. That is to say, a first pass through the process acts as a coarse focus adjustment, and the second pass through the process acts as a fine adjustment.

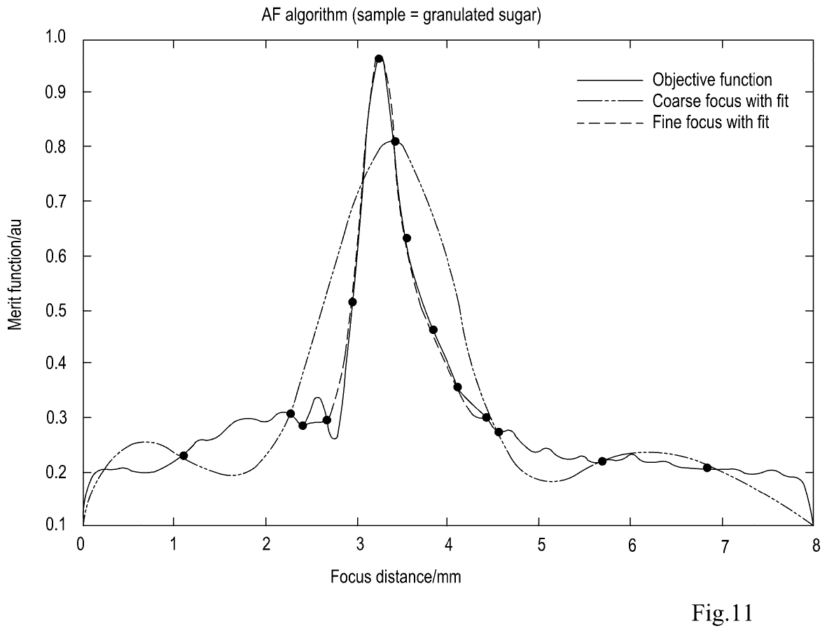

FIG. 11 shows a plot of the merit function as a function of focus position in a situation where two passes through the focusing process of FIG. 4 have been carried out, a first pass leading to a coarse fit and a second leading to a finer fit. The objective function is also plotted.

In a specific implementation of the above method, the lens may be moved at a constant velocity over a predefined range of motion at act 401. Moreover, in a specific implementation, a spline function may be fitted through the merit function values determined at act 403 as the second function mentioned at act 404.

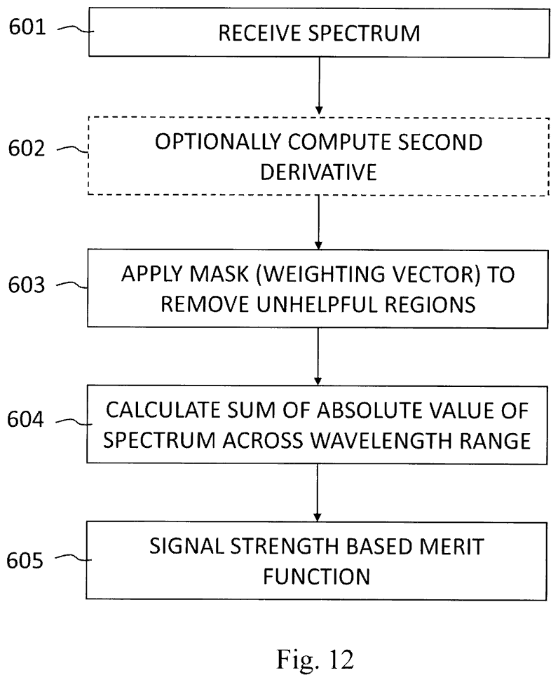

FIG. 12 is a flow chart showing in more detail the process performed by, e.g., the controller 1012, to determine the merit function as a measure of quality of focus at various positions as mentioned at act 403 in FIG. 10.

At act 601, the controller 1012 receives a spectrum from the detector 1010 corresponding to the spectrum obtained by the spectrometer with the focus position at a specific trial location.

At this stage an optional act 602 may be carried out to compute a second derivative spectrum from the received spectrum.

At act 603, the received spectrum (or the computed second derivative spectrum) is processed by applying a weighting vector and, in some embodiments, a mask—a weighting vector with values of 0 and 1. The weighting vector may be used to give a diminution or enhancement of signals in at least one selected wavelength range compared to detected signals received outside said at least one selected wavelength range. In the specific case where the weighting vector acts as a mask, application of the mask results in signals within at least one selected wavelength range being retained and signals outside of the at least one selected wavelength range being rejected or ignored.

In some embodiments, the mask is selected so that signals in a wavelength range where the containing material through which the spectra is obtained is known to have or may have a high Raman response are excluded from the autofocus determination. Performing this masking action in the process for determining the merit function can reduce the chance of a false focus being achieved on a layer of packaging or a wall of a container rather than on the sample itself.

At act 604, a sum of the absolute value of the spectrum across the wavelength range of interest is calculated. That is to say, the received spectrum (or computed second derivative spectrum) following application of the mask. Then at act 605, as a result of the summing operation at act 604, a signal strength based merit function is calculated based on the spectrum acquired with the focus in the respective trial position.

As it will be appreciated, in some embodiments, the process shown in FIG. 12 is repeated for each trial focus position in carrying out the process shown in FIG. 4.

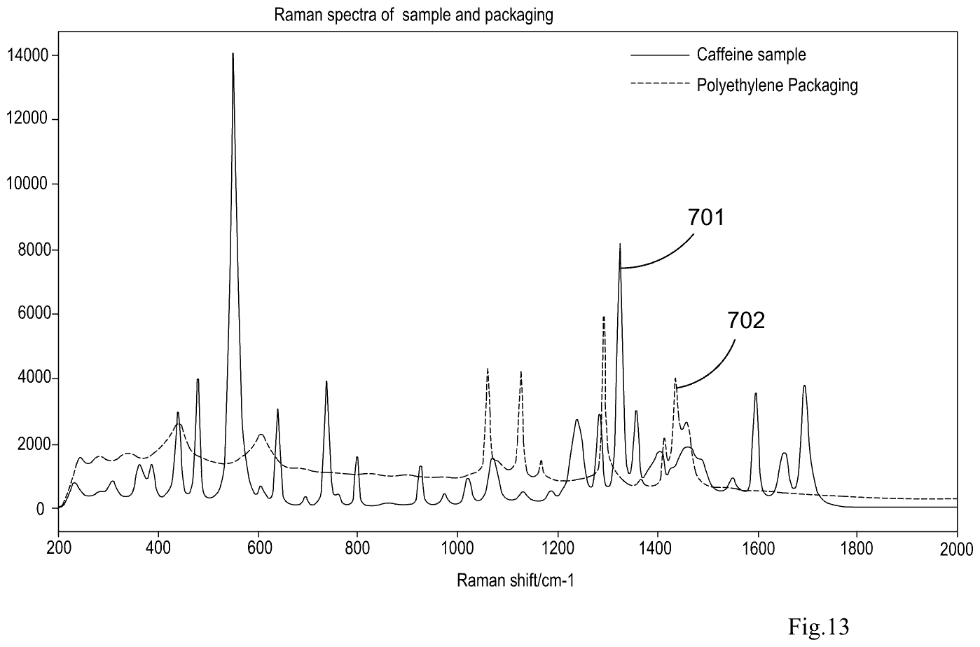

FIG. 13 shows an example plot of Raman spectra for an example sample, in this case a caffeine sample, and an example containing material, in this case a polyethylene packaging material. The plot shows how at various regions of the spectra there is a relatively strong Raman response both in the sample spectrum 701 and in the packaging spectrum 702, whereas in other regions there is a relatively mild response from the packaging but a comparatively large response from the sample.

It may also be noted in FIG. 13 that the Raman spectrum of the sample includes a number of relatively narrow peaks, whereas the Raman spectrum from the packaging includes more slowly varying peaks as well as some narrow peaks. At least some of these slowly varying peaks may be from other phenomenon rather than a Raman response. For example, they may be from fluorescence. In such a case taking the second derivative of the two spectra is particularly useful because the second derivative of the spectra gives a measure of how quickly the gradient of the spectrum changes with wavelength. As such, the response of slowly varying portions of the spectrum is reduced.

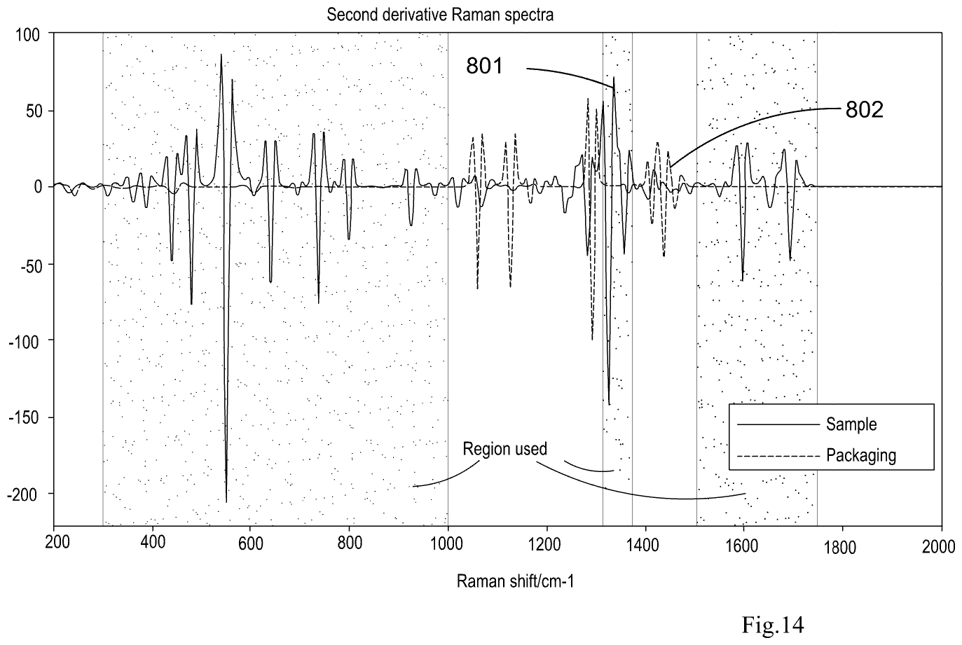

FIG. 14 shows a plot of the second derivatives of the two spectra in FIG. 13—the second derivative of the sample spectrum 801 and the second derivative of the packaging spectrum 802. As shown in FIG. 8 those regions of the packaging spectrum at wave number shifts between approximately 200 and 800 which are slowly varying in the original spectrum 702 are reduced to almost zero in the second derivative spectrum of the packaging material 802. This corresponds to making use of the optional act 602 in the process described in the flow chart of FIG. 12. As can be seen, where a packaging material has a Raman spectrum with slowly varying regions, using the second derivative of the spectra may be particularly useful.

FIG. 14 also illustrates a mask which may be used where the spectrometer is to be used with the particular sample and packaging pair of caffeine and polyethylene. The shaded regions in the plot of FIG. 14 correspond to the at least one selected wavelength ranges where the signal is retained for calculation of the signal-strength-based merit function, whereas the unshaded regions are rejected, e.g., not used in determining the merit function. Note that in at least this particular case, if the second derivatives were not used in the act of calculating the strength based merit function at acts 604 and 605, a rather different mask would have resulted.

In some embodiments, the controller 1012 is implemented on a computer including a storage device. This storage device holds amongst other things a library of possible investigation plans which the user may select based on the user's knowledge or expectation of the type of sample which is being investigated, and/or the type of containing material through which the spectrum may need to be acquired.

In some embodiments, the library of investigation plans can include specification of a suitable mask for use when obtaining a spectrum from a particular sample or type of samples, and/or with a particular packaging container material or type thereof, and more particularly may include a mask which is suitable for use when there is a particular pair of sample material and packaging/container material to be considered. Thus, for example, one such investigation plan in the present embodiment can include the mask illustrated in FIG. 14 for use when a user is testing a sample which is expected to be caffeine and the spectra are to be obtained through polyethylene packaging.

In some embodiments, the user may select the appropriate investigation plan using the display screen 1014, then depress the spectrum acquisition button 14, at which point the spectrometer performs the autofocusing processes described in relation to FIGS. 10 and 12 above. In some embodiments, while conducting these processes, the spectrometer may make use of the mask illustrated in FIG. 14 so as to exclude from the calculation of the signal strength based merit function those parts of the received spectra which emanate primarily from the polyethylene packaging.

In some embodiments, the spectrometer 1 can be loaded with a plurality of such investigation plans including appropriate masks for given samples for given packaging/container types, and for sample plus packaging/container type pairs. Furthermore, rather than having a whole investigation plan which includes other factors regarding the investigation beside the specification of a mask, in an alternative the spectrometer may be arranged to allow the selection of a specific mask separately. To put this another way, an investigation plan may include nothing other than a particular mask in some circumstances.

In some embodiments, the investigation plan, as well as containing parameters concerned with autofocus such as the mask, may also include other items. This might include, for example:

metadata concerning the sample itself (for example a barcode provided on a bulk sample packaging may be read into the spectrometer for association with the data which the spectrometer acquires);

details concerning the number of scans to be completed, the length of scans, and so on;

details of a matching algorithm and/or threshold for use in determining whether a sample under investigation is considered to match a particular target sample.

Thus, for example, the spectrometer may be used in a mode where the user expects a sample to be caffeine and the spectrometer uses a particular mask in autofocus, carries out a predetermined scan programme and provides an indication of whether caffeine has indeed been identified as the sample.

Note that in some embodiments, rather than being used for a situation where a sample is obscured from the spectrometer by the material of a container or packaging, the spectrometer may be used and the same focusing system useful where there is a layered sample of some kind. As an example, a sample may consist of a main ingredient at its core and a layer around the external core which is not of particular interest. In some such cases, the present spectrometer and the current focusing system may be used for focusing the spectrometer on the core such that the nature of the core may be ascertained by sampling, whilst the external layer is ignored.

In some embodiments, appropriate masks or weighting vectors in general for use in the autofocusing process may be developed off of the spectrometer 1 on a separate external computer. In principle, however, in an alternative, a spectrometer may be provided which allows the development of suitable masks or other weighting vectors on the spectrometer itself. In either case a similar process for determining a suitable mask may be followed.

In either case at a general level, a mask selection process may include a relatively high degree of human intervention, particularly in selecting the wavelength areas which are to be enhanced or retained and/or those to be rejected or diminished, or the process may be more automatic where a machine is used to automatically determine an appropriate mask or weighting vector.

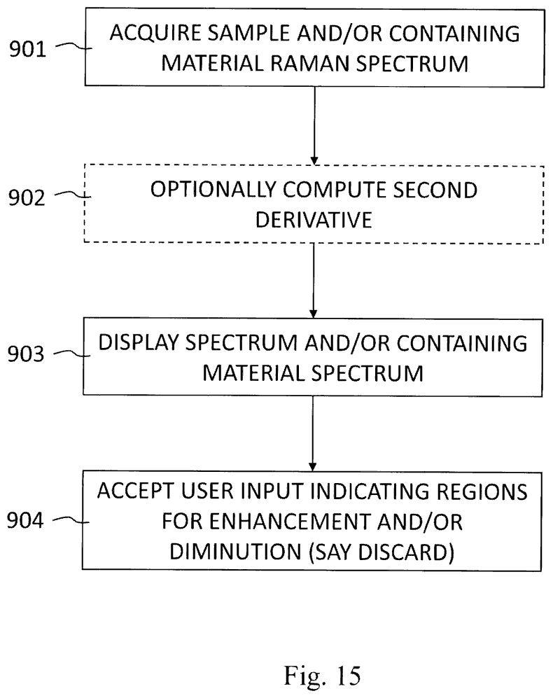

FIG. 15 shows a flow chart schematically illustrating a process for determining a mask for use in the present autofocusing methods which involves human intervention.

At act 901, a Raman spectrum for a particular sample type and/or a particular containing materials type are obtained. At act 902, optionally the second derivative of the or each spectrum may be computed. At act 903, the Raman spectrum and/or the second derivative of the Raman spectrum of the sample and/or the container material may be displayed to the user. With this spectrum or these spectra displayed to the user, the user can pick wavelength ranges which appear to be useful for measuring the strength of a received spectrum from a sample of that type and/or not showing a strong response from a packaging material of that type.

Once the user has made such decisions, at act 904, the computer or spectrometer accepts user input indicating regions for enhancement and/or diminution (which may include complete discarding of that spectral region) in order to form an appropriate weighting vector or mask.

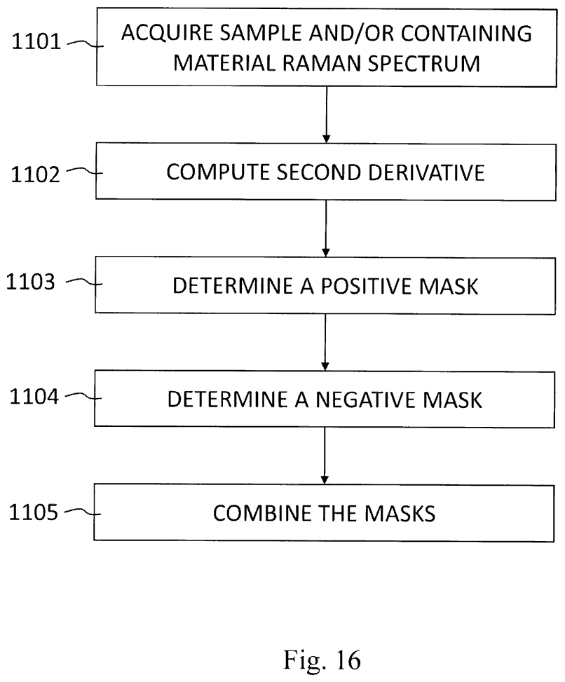

FIG. 16 shows a flowchart illustrating an automated process for generating a mask. At act 1101, Raman spectra for the sample and containing material are obtained. At act 1102, the second derivatives of the Raman spectra are computed. At act 1103, a positive mask is determined identifying those regions which have high response from the sample so on the face of it should be included in the process for calculating the merit function. At act 1104, a negative mask is determined by identifying those regions which have a high response from the containing material, and thus on the face of it should be excluded from the calculations of the merit function. At act 1105, the two masks are combined by computing a final mask as the positive mask determined at act 1103 AND NOT the negative mask determined at act 1104. This has the effect of providing a mask which will allow inclusion of those wavelength regions which are shown to have a high sample response, except sub-regions within those regions which also show a high containing material response.

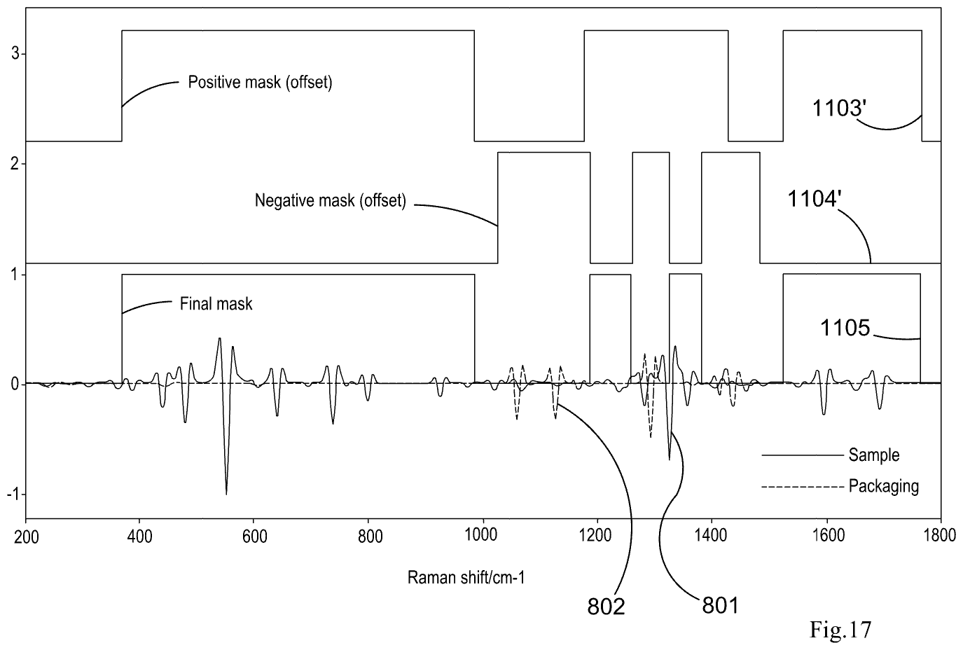

FIG. 17 is a plot showing an example positive mask 1103′, an example negative mask 1104′, an example final mask 1105′. The plot also shows the second derivative of the sample spectra 801 and the second derivative of the packaging spectra 802.

In an alternative the mask can also be selected by excluding regions where there is significant signal from the packaging material with all other regions being included.

Below is a more detailed explanation of a particular implementation of the process for automatically determining a mask described in relation to FIG. 16.

The mask can be selected automatically via an algorithm that analyses the spectra of the packaging material and the sample and derives a mask that is selective for the sample material. One such algorithm is outlined below and may be performed by, for example, the controller 1012.

Acquire spectra of the sample and the packaging material. The ordinate scale of the spectra should be comparable i.e. obtained under similar conditions and with good focus.

Compute the second derivative of both spectra using a suitable standard method (e.g. a Savitzky-Golay filter with the smoothing width chosen to suppress noise without significantly degrading resolution).

Determine a positive mask as follows. A mask here is an array of Boolean values the same size as the spectrum. Some of the manipulations below require the mask to be converted to floating point values with “true” corresponding to 1.0 and “false” corresponding to 0.0.

In the first iteration, the mask has a value of 1 at all wavelengths where the absolute value of the second derivative spectrum exceeds a preset threshold. This threshold could be chosen manually or it could be taken as the value corresponding to a certain multiple of the baseline noise, or a certain fraction of the height of the strongest peak.

Because of the nature of second derivative spectra, the resulting mask will tend to oscillate rapidly between true and false and it is desirable to produce a smoothed result that will have less sensitivity to the presence of impurities, small wavelength shifts, and other spectral artefacts. The mask is converted to floating point numbers and then convolved with a suitable smoothing filter (such as a triangular filter). The width of the filter is not a highly critical parameter but it should be on the order of the width of the Raman spectral lines. The resulting smoothed filter is then converted back to Boolean values by taking each value greater than a certain threshold as equivalent to True and values below the threshold as False. A typical value for this threshold is 0.25.

This smoothing process can be repeated several times, either until the user judges the mask satisfactory or the complexity is reduced to a preset number of nonzero segments.

Determine a negative mask as follows. Compute the ratio of the packaging spectrum to the sample spectrum, and initialise the mask with True values at wavelengths where the packaging material spectrum exceeds a certain threshold and where the ratio exceeds a second threshold. This second threshold typically would be a small value such as 0.1. Repeat the smoothing process detailed above (potentially with a different number of smoothing cycles).

The final mask is computed as (positive mask) AND NOT (negative mask).

In an alternative implementation, rather than using a weighting vector which is a Boolean mask with values of either one or zero as described above, a different approach may be followed. This leads to the possibility of calculating the weighting vector automatically in a different way, but then requires a different use of the weighting vector.

Where a Boolean mask is provided, i.e. a mask as defined above where the value is either one or zero, the mask may be applied by simply multiplying the spectra of interest with the mask. Of course, in doing this it will set the spectra to zero in those regions where the mask is zero.

On the other hand, where a non-Boolean weighting vector is provided, a different application process of the weighting vector may sometimes be appropriate.

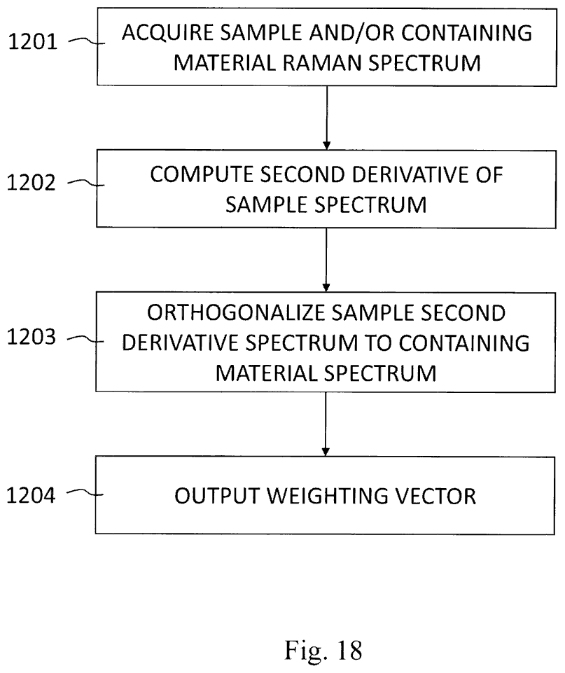

FIG. 18 is a flow chart schematically showing an alternative approach for calculating a weighting vector. Here in step 1201 Raman spectra for a sample and a containing material are acquired. In step 1202 the second derivative of the sample spectrum is computed. In step 1203 the second derivative of the sample spectrum is orthogonalized to the containing material spectrum, and in step 1204 this leads to the output of a weighting vector which will not be a Boolean mask but rather a spectrum which in many respects resembles one of the originally acquired spectrum.

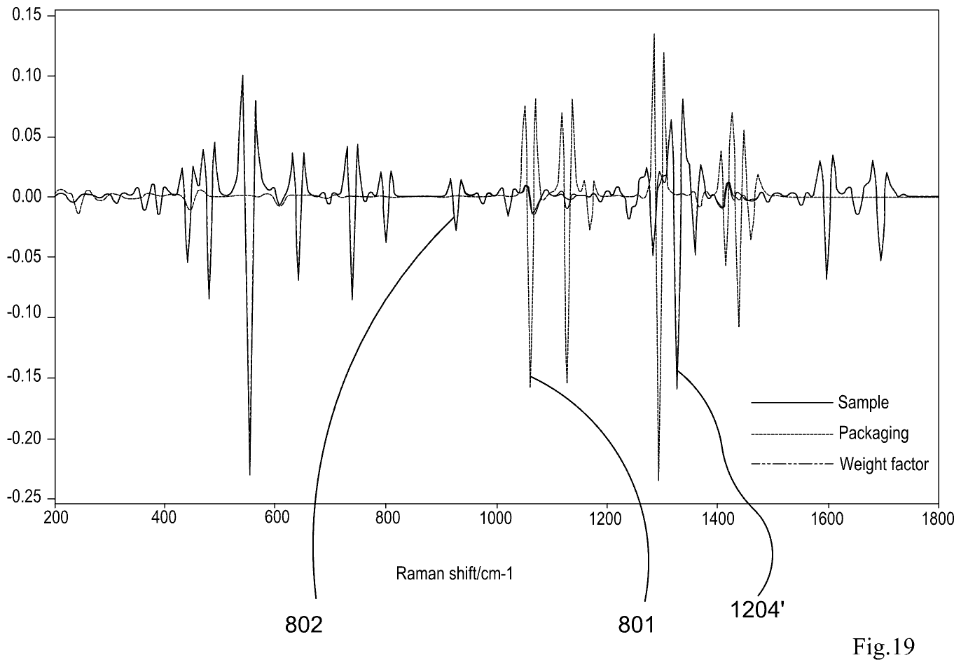

FIG. 19 is a plot showing the second derivative of the sample spectrum 802, the packaging spectra 801 and the weighting spectrum 1204′. In fact, the weighting spectrum 1204′ is almost invisible in the plot since it almost directly overlies the sample spectrum. This is because of the nature of the orthogonalization process means that the weighting vector has a correlation with the packaging second derivative spectra which is zero, and has a correlation with the sample second derivative spectrum which is as large as possible. In this case, when such a weighting vector is used the merit function is calculated as the dot product of the weighting vector 1204′ and the second derivative of the Raman spectrum which is obtained by the spectrometer at each trial focusing position.

Having thus described several aspects of at least one embodiment of the present invention, it is to be appreciated that various alterations, modifications, and improvements will readily occur to those skilled in the art. Such alterations, modifications, and improvements are intended to be part of this application and are intended to be within the spirit and scope of the present invention. Further, though advantages of some embodiments are indicated, it should be appreciated that not every embodiment will include every described advantage. Some embodiments may not implement any features described as advantageous herein. Accordingly, the foregoing description and drawings are by way of example only.

Some embodiments can be implemented in a number of ways. For example, some embodiments may be implemented using hardware, software or a combination thereof. When implemented in software, the software code can be executed on any suitable processor or collection of processors. Such processors may be implemented as integrated circuits, with one or more processors in an integrated circuit component.

Various aspects of the above-described embodiments may be used alone, in combination, or in a variety of arrangements not specifically discussed in the described embodiments. Embodiments are therefore not limited in their application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another, but are used merely as labels to distinguish one claim element having a certain name from another element having a same name (but for use of the ordinal term) to distinguish the claim elements.

The indefinite articles “a” and “an,” as used herein in the specification and in the claims, unless clearly indicated to the contrary, should be understood to mean “at least one.”

The phrase “and/or” as used herein in the specification and in the claims, should be understood to mean “either or both” of the elements so conjoined, i.e., elements that are conjunctively present in some cases and disjunctively present in other cases.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. The transitional phrases “consisting of” and “consisting essentially of” shall be closed or semi-closed transitional phrases, respectively.

1. A Raman spectrometer arrangement comprising:
a Raman spectrometer having a laser for illuminating a sample; and
a spectrometer accessory configured to be mounted on the spectrometer, wherein the spectrometer accessory comprises a surface configured to receive the sample,
wherein the Raman spectrometer arrangement is configured to operate in at least a first configuration and a second configuration, wherein:
the first configuration is such that the laser illuminates the sample before reaching a level of the surface; and
the second configuration is such that the laser reaches the level of the surface before illuminating the sample.

2. The Raman spectrometer arrangement according to claim 1 wherein the Raman spectrometer arrangement is configured to be usable in two orientations, a first orientation where the accessory acts as a base on which the Raman spectrometer arrangement is supportable in use and a second orientation where the spectrometer acts as a base on which the Raman spectrometer arrangement is supportable in use.

3. The Raman spectrometer arrangement according to claim 1, wherein:
the first configuration is such that the spectrometer accessory is in contact with a surface of a table and the Raman spectrometer not in contact with the table; and
the second configuration is such that the Raman spectrometer is in contact with the surface of the table and the spectrometer accessory is not in contact with the table.

4. The Raman spectrometer arrangement according to claim 1 in which the spectrometer arrangement comprises optical components for guiding radiation along an optical path from the laser to said surface configured for receiving the sample, the spectrometer comprises a main housing in which the laser is provided, and the spectrometer arrangement is arranged so that changing between the first configuration and the second configuration is achievable without a change in alignment of the optical path relative to the main housing.

5. The Raman spectrometer arrangement according to claim 1 wherein the spectrometer accessory comprises a main body comprising an opening through which a sample is introducible into the accessory for illumination when on the surface configured to receive the sample.

6. The Raman spectrometer arrangement according to claim 5 wherein the spectrometer accessory comprises a removable portion which comprises said surface configured to receive a sample such that a sample is depositable on the removable portion outside of the accessory before the removable portion is introduced through the opening into the main body.

7. The Raman spectrometer arrangement according to claim 1, wherein the spectrometer accessory comprises:
a main body comprising an opening; and
a drawer comprising said surface configured to receive the sample, the drawer being configured to be inserted in the opening of the main body in a first orientation and a second orientation, wherein:
the first orientation is such that the surface is facing upward when the Raman spectrometer arrangement is in the first configuration; and
the second orientation is such that the surface is facing upward when the Raman spectrometer arrangement is in the second configuration.

8. The Raman spectrometer arrangement according to claim 7 in which the accessory is arranged so that a sample is locatable on a side of the drawer which faces away from the spectrometer when the spectrometer arrangement is to be used in an orientation with the drawer above the spectrometer, wherein a window is provided in the drawer through which the beam of the laser and any resulting Raman emission may pass.

9. The Raman spectrometer arrangement according to claim 7 in which the accessory is arranged so that a sample is locatable on a side of the drawer which faces towards the spectrometer when the spectrometer arrangement is to be used in an orientation with the drawer below the spectrometer.

10. The Raman spectrometer arrangement according to claim 1 in which the spectrometer is arranged for operating in autofocus mode when the spectrometer is in one orientation and arranged for operating in a fixed focus mode when the spectrometer is in another orientation.

11. The Raman spectrometer arrangement according to claim 10 in which the spectrometer is arranged for operating in autofocus mode when a first type of accessory is mounted on the spectrometer and the spectrometer is in one orientation and is arranged for operating in a fixed focus mode when the first type of accessory is mounted on the spectrometer but the spectrometer is in another orientation.

12. The Raman spectrometer arrangement according to claim 1 in which the spectrometer comprises a screen for displaying information to a user, the screen being mounted for movement between a first position for use when the spectrometer is in a first orientation and a second position for use when the spectrometer is used in a second orientation.

13. The Raman spectrometer arrangement according to claim 12 in which in one state the screen projects from a main body of the spectrometer and helps support the spectrometer in use.

14. The Raman spectrometer arrangement according to claim 1, further comprising a fiber for coupling the laser to the sample.

15. The Raman spectrometer arrangement according to claim 1, further comprising an interlock mechanism for controlling operation of the laser wherein the interlock arrangement enables operation of the laser when the accessory is mounted on the spectrometer and disables operation of the laser when the accessory is not mounted on the spectrometer.

16. The Raman spectrometer arrangement according to claim 15 in which the accessory is selected from a set of accessories each of which is mountable on the spectrometer.

17. The Raman spectrometer arrangement according to claim 16 in which at least one of the accessories in the set is such as to lead to an overall spectrometer arrangement which can be classified as a Class I device notwithstanding the fact that the laser is a higher Class laser, whereas another of the accessories is such as to lead to an overall spectrometer arrangement which will be classified as a device which has the same Class as the Class of the laser.

18. The Raman spectrometer arrangement according to claim 1 in which the laser is driven by a laser current and the interlock arrangement is arranged to control operation of the laser by controlling the laser current.

19. The Raman spectrometer arrangement according to claim 1 in which the spectrometer arrangement comprises an electrical conduction path for carrying laser current between a power source and the laser, wherein the interlock arrangement comprises an electrical conductor portion which is provided in the accessory such that when the accessory is mounted on the spectrometer the electrical conductor portion forms part of the conduction path enabling operation of the laser and when the accessory is absent the conduction path is broken so disabling the laser.

20. The Raman spectrometer arrangement according to claim 1 in which the spectrometer comprises a pair of electrical contacts for connecting to the conduction path in the spectrometer and the accessory comprises a corresponding pair of electrical contacts for connecting to the electrical conductor portion in the accessory such that when the accessory is correctly installed on the spectrometer a first of the electrical contacts on the accessory mechanically and electrically contacts with a first of the electrical contacts on the spectrometer and a second of the electrical contacts on the accessory mechanically and electrically contacts with a second of the electrical contacts on the spectrometer so connecting the electrical conduction portion into the electrical conduction path.

21. The Raman spectrometer arrangement according to claim 1 in which the spectrometer comprises a focus system for focusing the beam of the laser on a sample wherein the focus system has an autofocus mode and a fixed focus mode.

22. The Raman spectrometer arrangement according to claim 1 in which the accessory is arranged so that when the accessory is installed on the spectrometer the laser beam path is obscured from view.

23. The Raman spectrometer arrangement according to claim 1 in which the accessory has an operative configuration in which a carried sample is to be illuminated by the laser and loading configuration for allowing loading of a sample into the accessory.

24. The Raman spectrometer arrangement according to claim 23 in which the accessory is arranged so that, when the accessory is installed on the spectrometer and in the operative configuration, the laser beam path is obscured from view.

25. The Raman spectrometer arrangement according to claim 23 in which the accessory comprises an electrical conductor portion which is provided in the accessory such that when the accessory is mounted on the spectrometer the electrical conductor portion forms part of the conduction path enabling operation of the laser and further comprises an accessory switch which when in an open state interrupts the conduction path via the electrical conductor portion so as to disable operation of the laser.

26. The Raman spectrometer arrangement according to claim 25 in which the accessory is arranged so that said accessory switch adopts the open state when the accessory is in the loading configuration.

27. The Raman spectrometer arrangement according to claim 25 wherein the spectrometer accessory comprises:
a main body comprising an opening; and
a drawer comprising said surface configured to receive the sample, the drawer being configured to be inserted in the opening of the main body in a first orientation and a second orientation, wherein:
the first orientation is such that the surface is facing upward when the Raman spectrometer arrangement is in the first configuration; and
the second orientation is such that the surface is facing upward when the Raman spectrometer arrangement is in the second configuration, further wherein, the drawer is movable between an open configuration in which the drawer is at least partly withdrawn from the main body of the accessory so allowing loading of a sample onto the drawer and a closed configuration where the surface configured to receive the sample is located within the main body of the accessory to allow illumination by the laser of a carried sample and wherein said accessory switch adopts the open state when the drawer is in the open configuration.

28. A Raman spectrometer arrangement kit comprising:
a Raman spectrometer having a laser for illuminating a sample; and
at least two spectrometer accessories each of which is selectably mountable on the spectrometer,
wherein at least one of the accessories comprises a surface configured to receive the sample and with said at least one of the accessories mounted on the spectrometer the Raman spectrometer arrangement is configured to operate in at least a first configuration and a second configuration, wherein:
the first configuration is such that the laser illuminates the sample before reaching a level of the surface; and
the second configuration is such that the laser reaches the level of the surface before illuminating the sample.

29. The Raman spectrometer arrangement kit according to claim 28, wherein:
the first configuration is such that said at least one spectrometer accessory is in contact with a surface of a table and the Raman spectrometer not in contact with the table; and
the second configuration is such that the Raman spectrometer is in contact with the surface of the table and said at least one spectrometer accessory is not in contact with the table.

30. The Raman spectrometer arrangement kit according to claim 28, wherein said at least one of the spectrometer accessories comprises:
a main body comprising an opening; and
a drawer comprising said surface configured to receive the sample, the drawer being configured to be inserted in the opening of the main body in a first orientation and a second orientation, wherein:
the first orientation is such that said surface is facing upward when the Raman spectrometer arrangement is in the first configuration; and
the second orientation is such that said surface is facing upward when the Raman spectrometer arrangement is in the second configuration.

31. The Raman spectrometer arrangement kit according to claim 28 further comprising an interlock arrangement for controlling operation of the laser wherein the interlock arrangement enables operation of the laser when either one of the accessories is mounted on the spectrometer and disables operation of the laser when neither accessory is mounted on the spectrometer.

32. The Raman spectrometer arrangement kit according to claim 31 in which at least one of the at least two spectrometer accessories is such as to lead to an overall spectrometer arrangement which will be classified as a Class I device notwithstanding the fact that the laser is a higher Class laser, whereas another of the at least two spectrometer accessories is such as to lead to an overall spectrometer arrangement which will be classified as a device which has the same Class as the Class of the laser.

33. The Raman spectrometer arrangement kit according to claim 28 in which one of the accessories comprises an interlock collar for mounting on the spectrometer for handheld use.

34. A Raman spectrometer accessory for mounting on a Raman spectrometer to form a Raman spectrometer arrangement configured to operate in at least a first configuration such that the spectrometer accessory is in contact with a surface of a table and the Raman spectrometer not in contact with the table and a second configuration is such that the Raman spectrometer is in contact with the surface of the table and the spectrometer accessory is not in contact with the table, the portable Raman spectrometer accessory comprising:
a main body comprising an opening; and
a drawer comprising a surface configured to receive the sample, the drawer being configured to be inserted in the opening of the main body in a first orientation and a second orientation, wherein:
the first orientation is such that the surface is facing upward when the Raman spectrometer arrangement is in the first configuration; and
the second orientation is such that the surface is facing upward when the Raman spectrometer arrangement is in the second configuration.

35. A Raman spectrometer arrangement comprising:
a Raman spectrometer having a laser for illuminating a sample,
a spectrometer accessory which is mountable on the spectrometer, and an interlock mechanism for controlling operation of the laser wherein the interlock arrangement enables operation of the laser when the accessory is mounted on the spectrometer and disables operation of the laser when the accessory is not mounted on the spectrometer.
